(19) United States
(12) Patent Application Publication
(10) Pub. No.: US 2023/0391365 A1
(43) Pub. Date: Dec. 7, 2023

(54) TECHNIQUES FOR GENERATING SIMULATIONS FOR AUTONOMOUS MACHINES AND APPLICATIONS

(71) Applicant: NVIDIA Corporation, Santa Clara, CA (US)

(72) Inventors: Boris Ivanovic, Mountain View, CA (US); Danfei Xu, Atlanta, GA (US); Yuxiao Chen, Sunnyvale, CA (US); Marco Pavone, Stanford, CA (US)

(21) Appl. No.: 18/114,035

(22) Filed: Feb. 24, 2023

Related U.S. Application Data
(60) Provisional application No. 63/349,583, filed on Jun. 6, 2022.

(51) Int. Cl. B60W 60/00; G06N 3/045

(52) U.S. Cl. CPC B60W 60/0011; B60W 60/00274; G06N 3/045; B60W 2554/4041; B60W 2554/4044; B60W 2554/80; B60W 2556/40

(57) ABSTRACT

In various examples, techniques for generating simulations for autonomous machines and applications are described herein. Systems and methods are disclosed that use various models to generate simulations. For instance, a first model(s) may process input data, such as input data representing maps indicating the locations of objects and state history of the objects within the environment, to determine navigation goals for the objects. Additionally, a second model(s) may then process the input data and data representing the navigation goals in order to determine possible trajectories (e.g., action samples) for the objects within the environment. Furthermore, a third model(s) may process the input data to predict trajectories of the objects within the environment. The systems and methods may then use at least the possible trajectories and the predicted trajectories to simulate the motion (e.g., one or more trajectories) of one or more of the objects.

### CROSS-REFERENCE TO RELATED APPLICATIONS

This application claims the benefit of U.S. Provisional Application No. 63/349,583, filed on Jun. 6, 2022, which is hereby incorporated by reference in its entirety.

### BACKGROUND

Simulation is an integral part of developing effective robotic systems. For instance, simulators allow developers to rapidly verify changes and triage erroneous behavior, such as erroneous driving behavior, before deploying the robotic systems in physical environments. For instance, realistic simulators are especially crucial for autonomous vehicles because it may be costly and potentially dangerous to test new features and changes directly on roads. However, despite the advances in simulations, autonomous vehicle developers still primarily rely on large-scale, real-world road testing for validation and verification. One critical reason is because existing simulation systems may not generate realistic behaviors for simulated road users, such as vehicles and pedestrians. This is because it may be challenging to design models that generate human-like behaviors from principles.

For instance, systems may use different approaches for generating simulations, such as microscopic simulation, which focuses on individual objects in traffic and simulating the objects' behaviors within the road. For instance, conventional systems that perform microscopic simulation use analytical models to control objects in a scene. For examples, the analytical models used by these conventional systems typically have fixed trajectories for vehicles to follow and separate longitudinal and lateral motions for other objects. Because of this, these conventional systems lack sufficient complexity and expressiveness when generating simulations for developing or evaluating autonomous driving features.

Other conventional systems may use learning-based approaches that ground reactive behavior generation in real-world driving logs. For instance, recent works show that trajectory forecasting models trained from large-scale driving logs may accurately infer distributions of future object trajectories in many challenging scenarios. While these learning-based approaches may excel at predicting realistic trajectories, these learning-based approaches may not perform well under domain shifts such as new environments with unseen driving behavior. Additionally, these learning-based approaches may not perform well when attempting to simulate the behavior of multiple objects within an environment. Furthermore, these learning-based approaches may not perform well when simulating the trajectories of objects over long periods of time since prediction errors may compound at each step of the simulation.

### SUMMARY

Embodiments of the present disclosure relate to techniques for generating simulations for autonomous machines and applications. Systems and methods are disclosed that use various models to generate simulations, where the models may decouple the generating of the simulations into high-level intent inferences and low-level goal-conditioned control. For instance, a first model(s) may process input data, such as input data representing maps (e.g., birds-eye-view maps) indicating the locations of objects and the state history of the objects within the environment, to determine navigation goals for the objects. Additionally, a second model(s) may then process the input data and data representing the navigation goals in order to determine possible trajectories (e.g., action samples) for the objects within the environment. Furthermore, a third model(s) may process the input data and, in some examples, state data associated with the objects to predict trajectories of the objects within the environment. The systems and methods may then use at least the possible trajectories and the predicted trajectories to simulate the motion (e.g., one or more trajectories) of one or more of the objects.

In contrast to conventional systems, such as those described above that use microscopic simulation, the current systems, in some embodiments, are able to generate simulations that include diverse, stable, and realistic traffic behaviors of objects. For instance, and as discussed above, these conventional systems use fixed trajectories for vehicles to follow and separate longitudinal and lateral motions for other objects. As such, these conventional systems lack sufficient complexity and expressiveness for developing or evaluating autonomous driving features. The current systems, in contrast, are able to more realistically simulate the behaviors of objects based on the model(s) that decouples the learning process into high-level intent inferences and low-level goal-conditioned control.

Additionally, in contrast to the conventional systems, such as the conventional systems that use the learning-based approaches, the current systems, in some embodiments, are able to accurately simulate the trajectories of multiple objects within the environment, even when performing simulations in new environments and/or when objects perform unseen maneuvers. Additionally, in contrast to these conventional systems, and as described in more detail herein, the current systems are able to accurately simulate the trajectories of the objects over long periods of time. Again, the current systems are able to more realistically simulate the behaviors of the objects based on the model(s) that decouple the learning process into high-level intent inferences and low-level goal-conditioned control.

### BRIEF DESCRIPTION OF THE DRAWINGS

The present systems and methods for techniques for generating simulations for autonomous machines and applications are described in detail below with reference to the attached drawing figures, wherein:

FIG. 1 illustrates an example data flow diagram for a process of generating simulations for objects, in accordance with some embodiments of the present disclosure;

FIG. 2 illustrates an example of input data for generating simulations of objects, in accordance with some embodiments of the present disclosure;

FIG. 3 illustrates an example of determining goals associated with an object, in accordance with some embodiments of the present disclosure;

FIG. 4 illustrates an example of determining actions associated with an object, in accordance with some embodiments of the present disclosure;

FIG. 5 illustrates an example of determining trajectories associated with nearby objects, in accordance with some embodiments of the present disclosure;

FIG. 6 illustrates an example of using a collision rule when determining a cost associated with an action, in accordance with some embodiments of the present disclosure;

FIG. 7 illustrates an example of simulating trajectories for objects within an environment, in accordance with some embodiments of the present disclosure;

FIG. 8 illustrates another example of simulating trajectories for objects within an environment, in accordance with some embodiments of the present disclosure;

FIG. 9 illustrates an example of generating diverse simulations, in accordance with some embodiments of the present disclosure;

FIG. 10 is a data flow diagram illustrating a process for training a spatial component, in accordance with some embodiments of the present disclosure;

FIG. 11 is a data flow diagram illustrating a process for training a conditional component, in accordance with some embodiments of the present disclosure;

FIG. 12 is a data flow diagram illustrating a process for training a selection component, in accordance with some embodiments of the present disclosure;

FIG. 13 is a flow diagram showing a method for generating a simulation associated with an object, in accordance with some embodiments of the present disclosure

FIG. 14A is an illustration of an example autonomous vehicle, in accordance with some embodiments of the present disclosure;

FIG. 14B is an example of camera locations and fields of view for the example autonomous vehicle of FIG. 14A, in accordance with some embodiments of the present disclosure;

FIG. 14C is a block diagram of an example system architecture for the example autonomous vehicle of FIG. 14A, in accordance with some embodiments of the present disclosure;

FIG. 14D is a system diagram for communication between cloud-based server(s) and the example autonomous vehicle of FIG. 14A, in accordance with some embodiments of the present disclosure;

FIG. 15 is a block diagram of an example computing device suitable for use in implementing some embodiments of the present disclosure; and

FIG. 16 is a block diagram of an example data center suitable for use in implementing some embodiments of the present disclosure.

### DETAILED DESCRIPTION

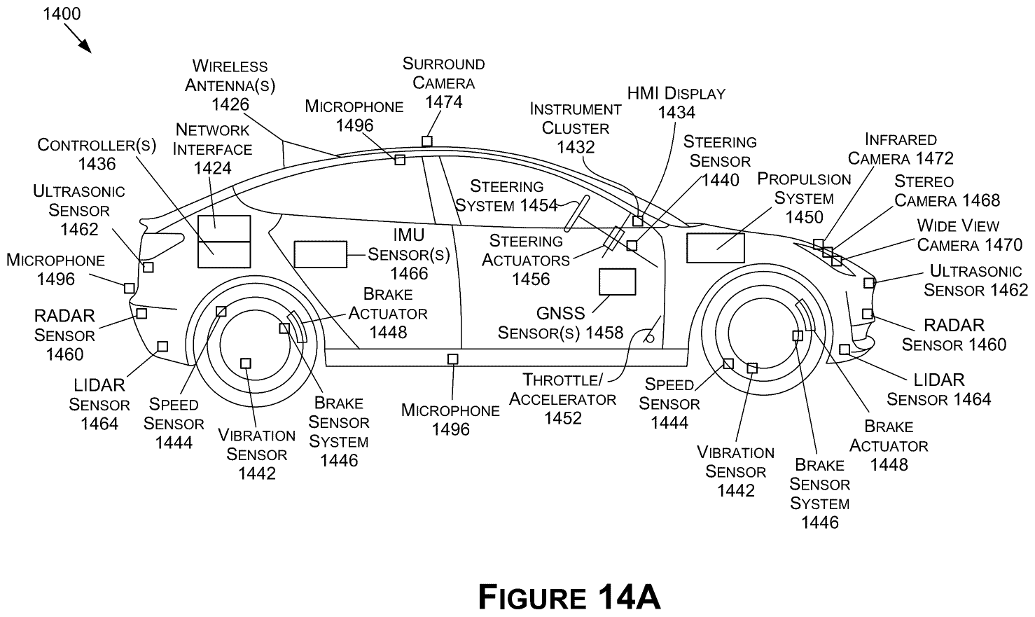

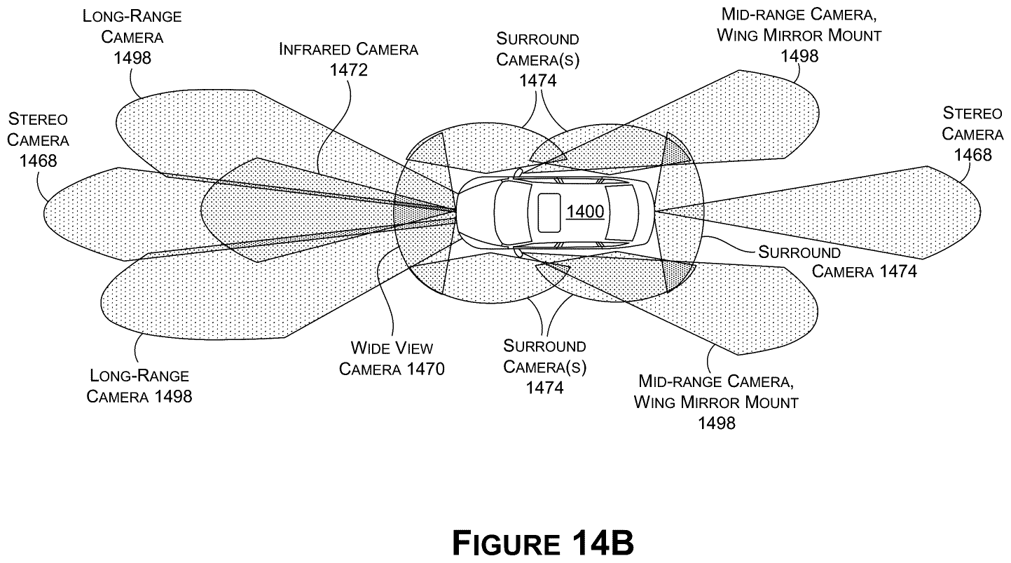

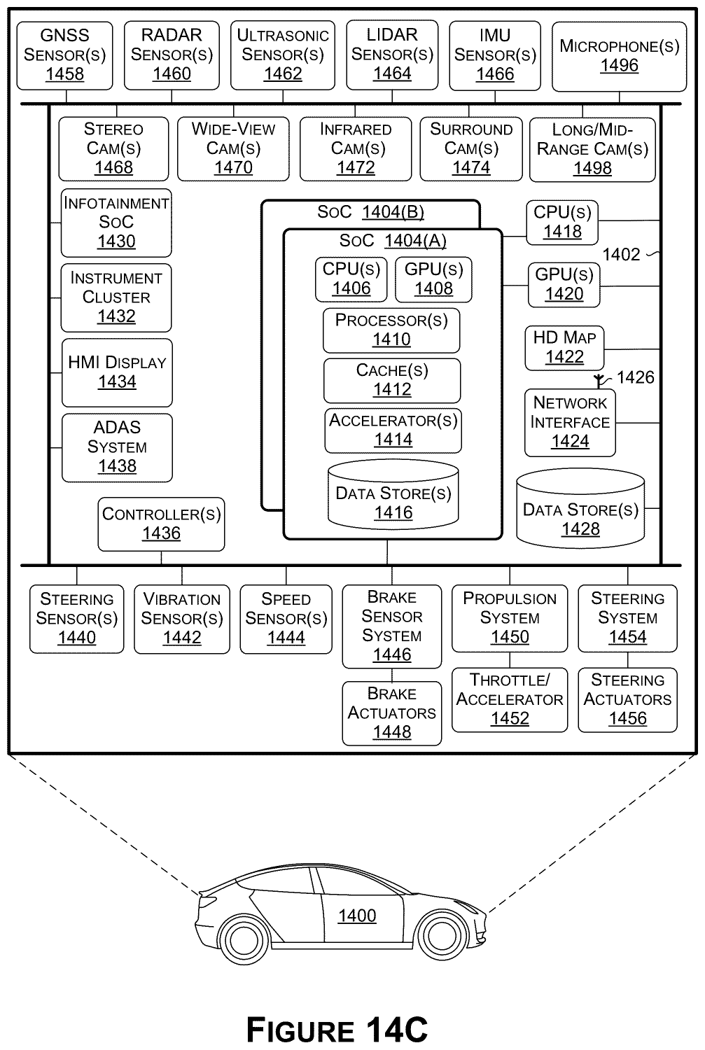

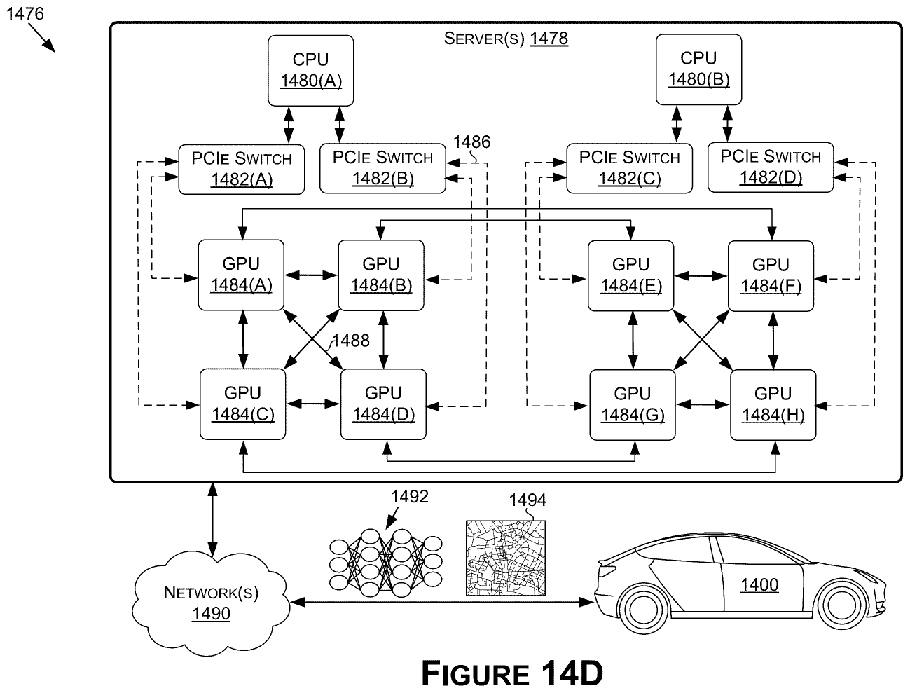

Systems and methods are disclosed related to techniques for generating simulations for autonomous machines and applications. Although the present disclosure may be described with respect to an example autonomous vehicle 1400 (alternatively referred to herein as “vehicle 1400” or “ego-vehicle 1400,” an example of which is described with respect to FIGS. 14A-14D), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to data simulation for vehicles, this is not intended to be limiting, and the systems and methods described herein may be used in augmented reality, virtual reality, mixed reality, robotics, security and surveillance, autonomous or semi-autonomous machine applications, and/or any other technology spaces where data simulation may be used.

For instance, a system(s) may generate data (referred to, in some examples, as “input data”) that is input into models that are trained to generate simulations. In some examples, the system(s) generates at least a portion of the input data using log data representing information associated with objects within a real-world environment(s). The information for an object may include, but is not limited to, locations of the object at various time instances, velocities of the object at the various time instances, accelerations of the object at the various time instances, directions of travel of the object at the various time instances, a classification (e.g., vehicle, pedestrian, animal, etc.) associated with the object, a map representing an environment that the object was navigating, and/or any other information. In some examples, the input data may represent one or more maps (e.g., one or more birds-eye-view maps) indicating the locations of the objects at a given instance in time and history information for the objects prior to the given instance in time. In some examples, the input data may include a tensor that represents the map(s) and the history information.

The system(s) may then input at least a portion of the input data into a first model(s) that is trained to generate data (referred to, in some examples, as “goals data”) representing one or more navigational goals associated with one or more of the objects after the given instance in time. For instance, and for an object, the first model(s) may determine one or more locations (e.g., a two-dimensional location(s), a pose(s), etc.) for which the object may be located over a given period of time (e.g., one second, three seconds, five seconds, ten seconds, etc.) and/or one or more directions of travel of the object over the given period of time. In some examples, and for an object, the goals data may represent a map, such as a 2D heatmap and/or grid map, indicating the location(s) and/or the direction(s) of travel over the given period of time. In some examples, the goals data may include a tensor that includes the same spatial size as the tensor of the input data.

The system(s) may also input at least a portion of the input data and/or at least a portion of the goals data into a second model(s) that is trained to generate data (also referred to, in some examples, as “actions data”) representing one or more actions associated with the one or more navigational goals of the one or more objects. For instance, and for an object, the second model(s) may determine one or more predicted trajectories associated with the object over the given period of time. In some examples, to determine the one or more predicted trajectories, the second model(s) may predict, based on the goal(s), the controls of the object at future time steps within the given period of time, where the controls may include the respective location, velocity, acceleration, direction of travel, and/or the like associated with the object at each time step. The second model(s) may then forward integrate the controls through the object's dynamic model.

The system(s) may also input at least a portion of the input data and/or state data associated with the objects into a third model(s) that is trained to generate data (referred to, in some examples, as “trajectory data”) representing predicted trajectories of the objects over the given period of time. In other words, and for an object, the first model(s) may be trained to generate goals data representing one or more navigational goals associated with the object over the given period of time, the second model(s) may be trained to generate actions data representing one or more actions (e.g., one or more future trajectories) of the object over the given period of time, and the third model(s) may be trained to generate trajectory data representing predicted trajectories for other objects over the given period of time. The system(s) may then use the goals data, the actions data, and/or the trajectory data to determine a simulated trajectory for the object.

For instance, and as described in more detail herein, the system(s) may use at least the actions data and the trajectory data determine a respective cost associated with one or more (e.g., each) of the action(s) associated with the object. In some examples, the system(s) may further use one or more rules when determining the cost(s), such as a collision rule that is associated with distances between the object and the other objects when navigating according to the action(s) and a road departure rule that is associated with whether the action(s) would cause the object to navigate outside of a drivable area (e.g., off the roads). The system(s) may then select an action based on the cost(s). As described herein, the selected action may include a simulated trajectory for the object over the given period of time. In some examples, the system(s) may then perform similar processes to determine one or more simulated trajectories for one or more other objects over the given period of time.

In some examples, the system(s) may continue to perform these processes, but with using at least a portion of the simulated trajectories for the objects, in order to continue to generate the simulation. For instance, as described herein, the system(s) may use current locations of the objects at a given instance in time and history information associated with the objects prior to the given instance in time to determine these simulated trajectories, where the simulated trajectories are over the given future period of time that is after the given instance in time. As such, the system(s) may perform similar processes, but with updating the given instance of time, to continue extending the length of the simulation.

For example, the initial instance it time may be associated with time “0” seconds, the history information may be associated with a time interval of three seconds prior to the initial instance in time, such as between “−3” seconds and “0” seconds, and the given period of time may be associated with three seconds after the initial instance of time, such as between “0” seconds and “3” seconds (although these are only example time intervals and, in other examples, the system(s) may use different time intervals). As such, when performing the processes again, the updated instance in time may include time “0.5” seconds, the history information may be associated with another time interval of three seconds prior to the updated instance in time, such as between “−2.5” seconds and “0.5” seconds, and the given period of time may again be associated with three seconds after the updated instance in time, such as between “0.5” seconds and “3.5” seconds. In such an example, the history information between “0” seconds and “0.5” seconds may come from the simulated trajectories associated with the objects.

The system(s) may then continue to perform these processes in order to continue determining the simulated trajectories for the objects. For instance, the system(s) may continue to perform these processes until the simulated trajectories reach a threshold, such as a threshold time into the future (e.g., a threshold period of time after time “0” seconds in the example above,), a threshold distance (e.g., a threshold distance from the original locations of the objects at time “0” seconds in the example above), and/or the like. By performing such processes to incrementally determine the simulated trajectories of the objects, the system(s) may determine simulated trajectories that are stable and imitate realistic behaviors (e.g., driving behaviors) of objects. Additionally, each time the system(s) performs these processes to generate simulations, even if the same input data is initially used, the system(s) may generate diverse simulations associated with the environment.

In some examples, the system(s) may use at least a portion of the log data to train the models to perform the processes described herein. For example, the system(s) may use at least a portion of the log data to train the first model(s) to determine navigational goals associated with objects, use at least a portion of the log data to train the second model(s) to determine actions associated with the navigational goals of the objects, and/or use at least a portion of the log data to train the third model(s) to predict trajectories of objects. In some examples, the system(s) is able to train the models using the log data since, as described herein, the log data represents maps of environments and actual behaviors (e.g., locations, velocities, accelerations, directions of travel, trajectories, etc.) of objects within the environments.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

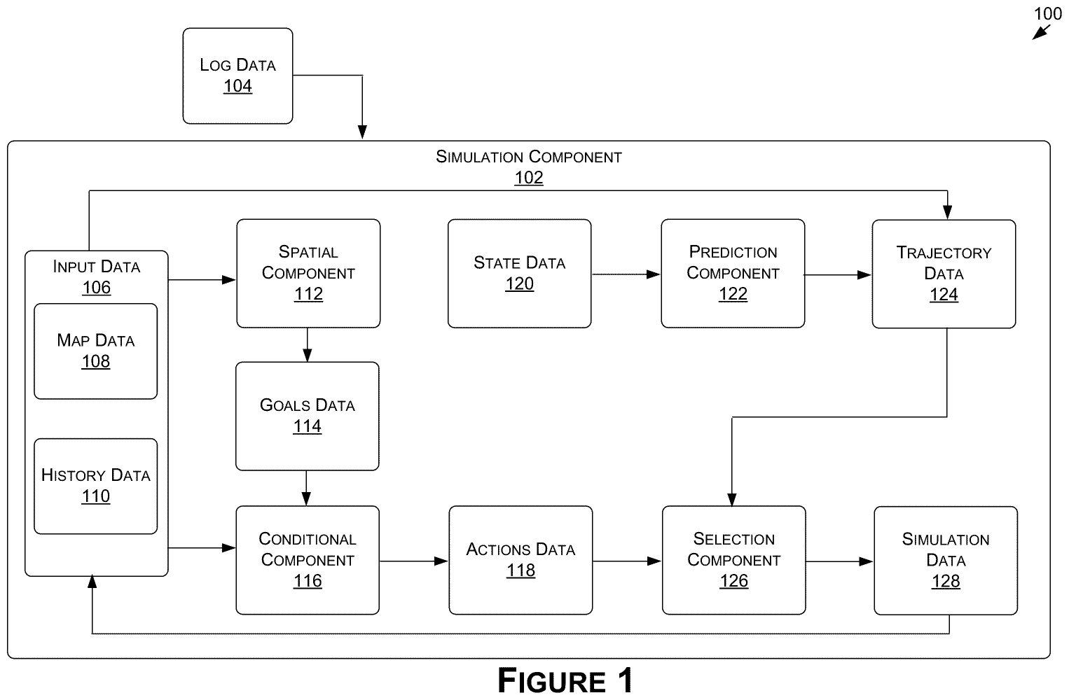

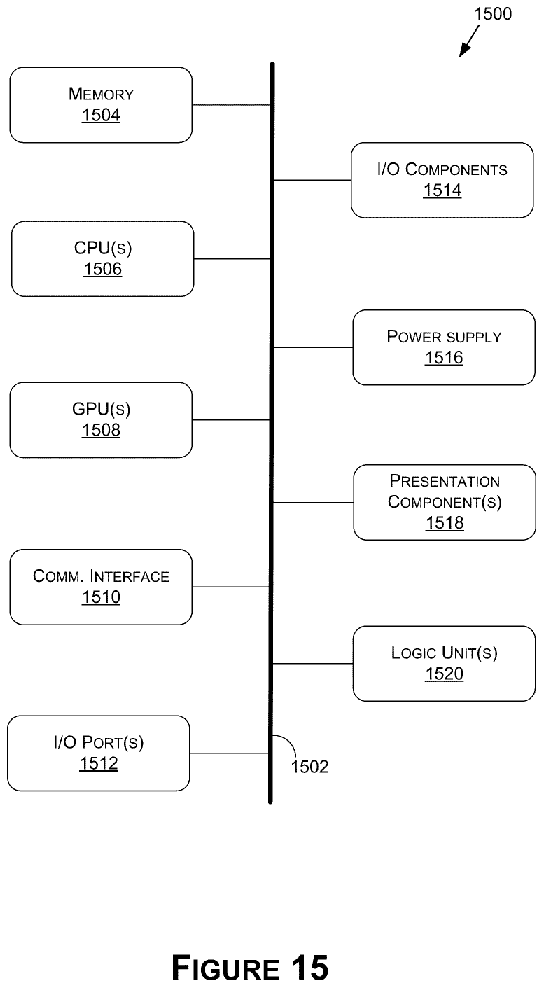

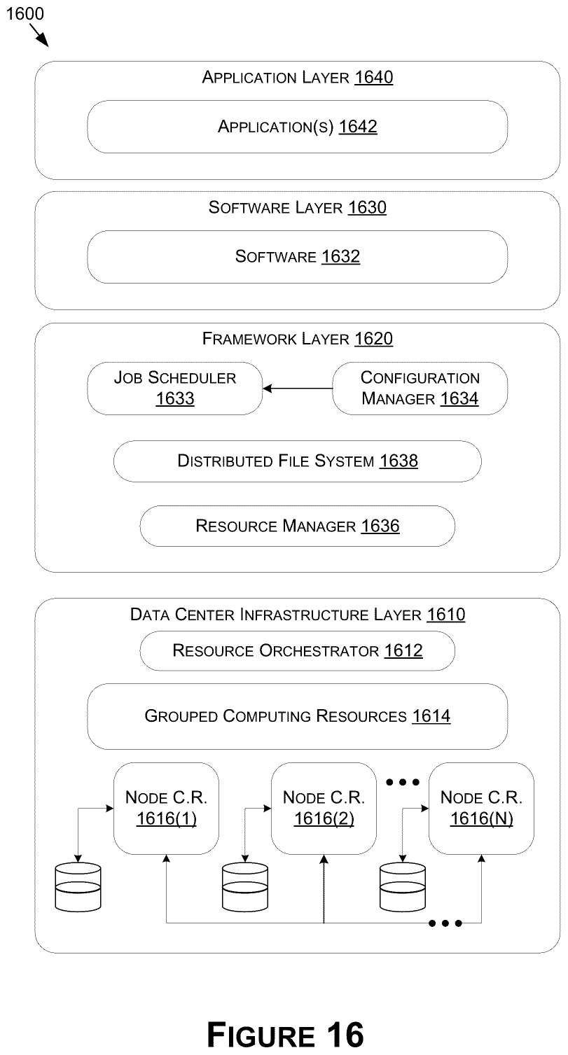

With reference to FIG. 1, FIG. 1 illustrates an example data flow diagram for a process of generating simulations for objects, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1400 of FIGS. 14A-14D, example computing device 1500 of FIG. 15, and/or example data center 1600 of FIG. 16.

The process 100 may include a simulation component 102 that receives log data 104 representing information associated with objects within a real-world environment(s). As described herein, the information for an object may include, but is not limited to, locations of the object at various time instances, velocities of the object at the various time instances, accelerations of the object at the various time instances, directions of travel of the object at the various time instances, a classification (e.g., vehicle, pedestrian, animal, etc.) associated with the object, a map representing an environment for which the object was navigating, and/or any other information. In some examples, since the log data 104 represents the maps and the behaviors of the objects, the simulation component 102 may treat the driving logs represented by the log data 104 as a set of multi-object expert demonstration sequences to formulate the simulations.

For instance, the process 100 may include the simulation component 102 generating input data 106 using at least the log data 104. As shown, the input data 106 may include at least map data 108 and history data 110. The map data 108 may represent one or more maps indicating the locations of objects within an environment at a given instance in time. In some examples, the simulation component 102 generates a respective map for one or more (e.g., each) of the objects, where the object for which a map is generated is located proximate to a center of the map. In some examples, a map may include a rasterized semantic map representing the locations of the objects within the environment.

The history data 110 may then include history information associated with the objects during a time interval that is prior the given instance in time. The time interval may include, but is not limited to, 1 second, 3 seconds, 5 seconds, 10 seconds, and/or any other time interval. Additionally, the history information for an object may include, but is not limited to, locations of the object at time steps within the time interval, velocities of the object at the time steps, accelerations of the object at the time steps, directions of travel of the object at the time steps, and/or any other information. The time steps may include, but are not limited to, 0.1 seconds, 0.5 seconds, 1 second, and/or any other instance in time.

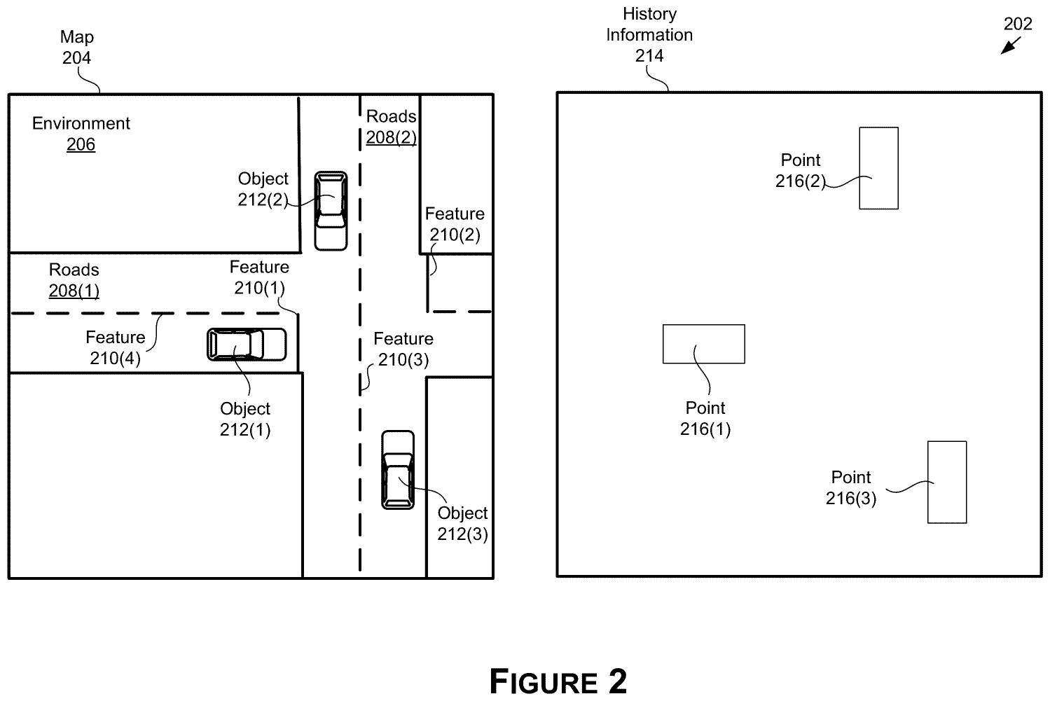

For instance, FIG. 2 illustrates an example of input data 202 (which may represent, and/or include, the input data 106) for generating simulations of objects, in accordance with some embodiments of the present disclosure. As shown, the input data 202 may include map data representing a map 204 of an environment 206. The map 204 may include information associated with the environment, such as the locations of roads 208(1)-(2) within the environment 206, the locations of traffic features 210(1)-(4) (e.g., road markings, traffic signs, etc.) within the environment 206, and/or any other information associated with the environment 206 (e.g., any other information that may impact how objects navigate within the environment 206). Additionally, the map 204 may indicate locations of objects 212(1)-(3) (also referred to singularly as “object 212” or in plural as “objects 212”) at a given instance in time. While each of the objects 212 includes a vehicle in the example of FIG. 2, in other examples, the objects may include other types of objects (e.g., pedestrians, animals, structures, etc.).

The input data 202 may also include history data representing information 214 associated with the objects 212. For instance, the information 214 may include the locations, velocities, accelerations, directions of travel, and/or any other information associated with the objects 212 during a time interval that is prior to the given instance of time associated with the map 204. For example, and as shown, the information 214 includes at least the locations and directions of travel of the objects during the time interval, where the locations and directions of travel are indicated by points 216(1)-(3) (e.g., bounding shapes). While the example of FIG. 2 illustrates only one instance of history information 214 associated with the map 204, in other examples, the input data 202 may include multiple instances of history information 214 associated with the map 204. In such examples, each instance of the history information 214 may be associated with a respective time step that within the time interval.

Additionally, while the example of FIG. 2 illustrates the input data 202 as representing a single map 204, in other examples, the input data 202 may represent multiple maps. For example, the input data 202 may represent a respective map for one or more (e.g., each) of the objects 212 within the environment 206. In such examples, the map associated with an object 212 may include the object 212 located substantially at a center of the map. For example, and as illustrated by the example of FIG. 2, the map 204 may be associated with the object 212(1) such that the object 212(1) is located substantially at the center of the map 204.

Referring back to the example of FIG. 1, and for more detail, the simulation component 102 may take an object-centric approach where objects (e.g., each of the objects) make decisions in a decentralized manner without explicit coordination. This may allow for flexible integration with existing simulation frameworks containing other types of simulated objects and encourages the emergence of new interactive behaviors. As such, the simulation component 102 may use s and c to denote the dynamic state and decision-relevant context (e.g., which may represent, and/or include, the input data 106) for an object, respectively. In some examples, the state s includes the position, direction of travel, and velocity of an object. The context c=(I, S) may include a local semantic map I (e.g., a map represented by the map data 108) and h previous states of an object (e.g., represented by the history data 110) and its N neighboring objects illustrated by:

S_{t-h:t}={s_{t-h:t}⁽⁰⁾,s_{t-h:t}⁽¹⁾, . . . ,s_{t-h:t}^{(N)}} (1)

Given the decision context information cₜ and the current state sₜ, the goal of the traffic simulation model π_{θ} (e.g., the entire process 100) is to generate the next state of the object, which is represented by:

sₜ₊₁= [symbol] (π_{θ}(cₜ),sₜ) (2)

In some examples, equation (2) may be subject to a dynamic transition function, such as [symbol] (⋅). Since the log data 104 representing the driving logs may readily include semantic maps and the trajectories of the objects, the simulation component 102 may treat the driving logs as a set of multi-object expert demonstration sequences by:

τ={c₀⁽ⁱ⁾,s₀⁽ⁱ⁾,c₁⁽ⁱ⁾,s₂⁽ⁱ⁾, . . . ,c_{T}⁽ⁱ⁾,s_{T}^{(i),}}ₜ₌₀^{N} (3)

The simulation component 102 may then use equation (3) to formulate the traffic simulation as a supervised imitation learning problem. As described here, the goal of the simulation is to produce plausible behaviors by learning from real-world driving logs as demonstrations. For instance, and as described below, a spatial component 112 is trained to predict the distribution of the short-term goal pose (e.g., 2D position and direction of travel) p(ś_{t+H}|cₜ) of an object given the object's context cₜ. As such, the simulation component 102 may encode the decision context into a rasterized semantic map, which includes the semantic map I and past agent trajectories rasterized as 2D bounding shapes (e.g., bounding boxes) in additional channels.

The process 100 may include inputting at least a portion of the input data 106 into the spatial component 112 that is trained to generate data 114 (referred to, in some examples, as “goals data 114”) representing one or more navigational goals associated with one or more of the objects after the given instance in time. For instance, and for an object, the spatial component 112 may determine one or more locations (e.g., a two-dimensional location(s), a pose(s), etc.) for which the object may be located over a given period of time (e.g., one second, three seconds, five seconds, ten seconds, etc.) and/or one or more directions of travel of the object over the given period of time. In some examples, and for an object, the goals data 114 may represent a map, such as a 2D heatmap, indicating the location(s) and/or the direction(s) of travel over the given period of time. In some examples, the goals data 114 may include a tensor that includes the same spatial size as the tensor of the input data 106.

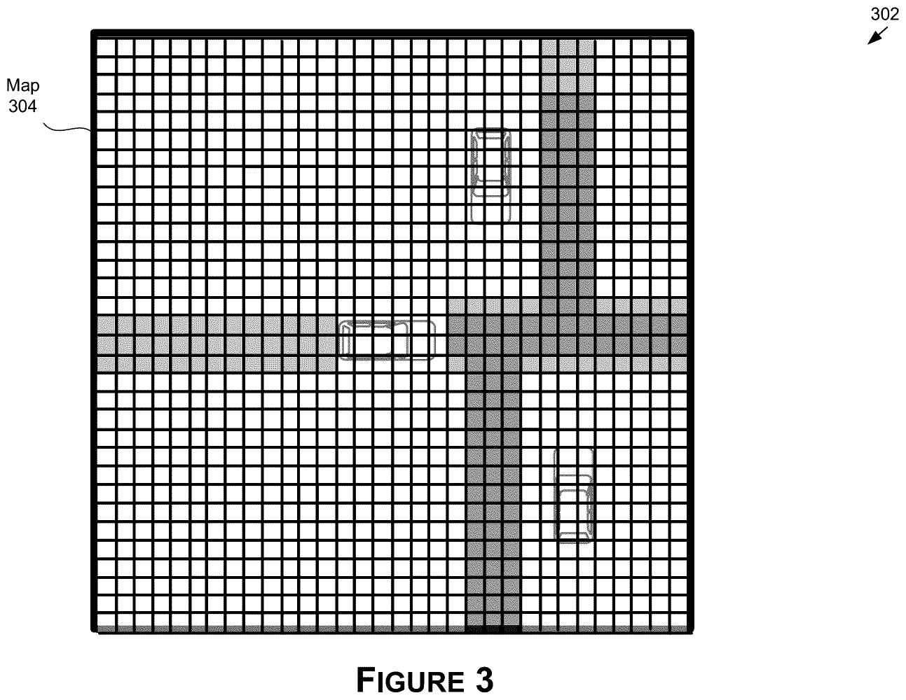

For instance, FIG. 3 illustrates an example of goals data 302 (which may represent, and/or include, the goals data 114) representing goals associated with the object 212(1), in accordance with some embodiments of the present disclosure. As shown, the goals data 302 may represent a map 304 that indicates the goals associated with the object 212(1) within the environment 206. For instance, the goals may indicate predicted locations that the object 212(1) may be located at after the given period of time elapses and/or the locations that the object 212(1) may be located at over the given period of time. In the example of FIG. 3, the map 304 includes a 2D grid map, such as a heatmap, that indicates the locations of the object 212(1) over the given period of time. For example, the darker the square within the map 304, the higher the probability that the object 212(1) will be located at that location over the given period of time. Additionally, the lighter the square within the map 304, the lower the probability that the object 212(1) will be located at that location over the given period of time.

While the example of FIG. 3 illustrates a single map 304 for a single object 212(1) within the environment 206, in other examples, the spatial component 112 may generate a respective map for one or more (e.g., each) of the objects 212. For example, the spatial component 112 may further generate a map representing the goals associated with the object 212(2) and/or a map representing the goals associated with the object 212(3). In some examples, the object 212 for which the map is generated may be located substantially within a center of the map. For example, and as illustrated by the example of FIG. 3, the map 304 may be associated with the object 212(1) such that the object 212(1) is located substantially at the center of the map 304.

Referring back to the example of FIG. 1, and for more detail, the spatial component 112 takes as input the input data 106 (e.g., the rasterized semantic map represented by the map data 108 and/or the history information represented by the history data 110) and outputs a 2D grid goal likelihood as well as residual components to refine the predicted goal locations. For example, the output, which may be represented by the goals data 114, may include a tensor with a given number of channels (e.g., 2-channel, 4-channel, etc.). In some examples, the output from the spatial component 112 includes the same spatial size as the inputted rasterized map. In some examples, such as when the tensor includes 4 channels, channel 0 is the likelihood of the coarse goal location 2D probability map, each pixel in channel 1 and channel 2 is the (x, y) scalar residual relative to the grid location, and channel 3 is the direction of travel prediction at each grid location. Once the location is selected based on the probability map in channel 0, the location is corrected by the residual and transformed into a goal pose ś_{t+H} in the object's local coordinate frame.

The process 100 may include inputting at least a portion of the input data 106 and/or at least a portion of the goals data 114 into a conditional component 116 that is trained to generate data 118 (also referred to, in some examples, as “actions data 118”) representing one or more actions associated with the one or more navigational goals of the one or more objects. For instance, and for an object, the conditional component 116 may determine one or more predicted trajectories associated with the object over the given period of time. In some examples, to determine the one or more predicted trajectories, the conditional component 116 may predict the controls of the object at future time steps within the given period of time, where the controls may include the respective location, velocity, acceleration, direction of travel, and/or the like associated with the object at each time step. The conditional component 116 may then forward integrate the controls through the object's dynamic model.

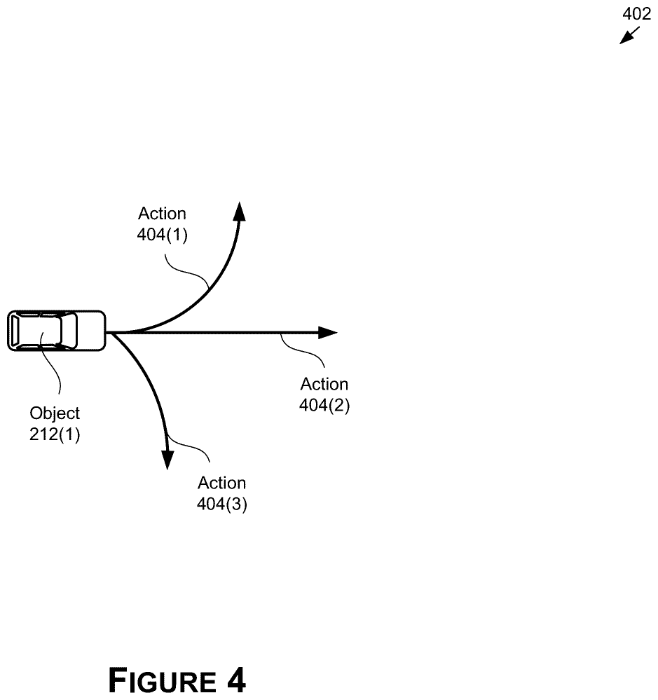

For instance, FIG. 4 illustrates an example of actions data 402 (which may represent, and/or include, the actions data 118) representing actions 404(1)-(3) (also referred to singularly as “action 404” or in plural as “actions 404”) associated with the object 212(1), in accordance with some embodiments of the present disclosure. As shown, the conditional component 116 may determine that the actions 404 associated with the object 212(1) include a first action 404(1) where the object 212(1) navigates along a left turn (e.g., onto the road 208(2)), a second action 404(2) where the object 212(1) continues navigating straight (e.g., along the road 208(1)), and a third action 404(3) where the object 212(1) navigates along a right turn (e.g., onto the road 208(2)). While the example of FIG. 4 illustrates the conditional component 116 as determining three actions 404 for the object 212(1), in other examples, the conditional component 116 may determine any number of actions for the object 212(1) (e.g., one action, two actions, five actions, ten actions, twenty actions, etc.).

Additionally, while the example of FIG. 4 illustrates determining actions 404 for a single object 212(1) within the environment 206, in other examples, the conditional component 116 may determination actions for one or more (e.g., each) of the objects 212. For example, the conditional component 116 may further determine an action(s) associated with the object 212(2) within the environment 206 and/or an action(s) associated with the object 212(3) within the environment.

Referring back to the example of FIG. 1, and for more detail, the goal-conditional policy may take the form of a deterministic trajectory generator by:

s_{t:t+H}=π_{θ}(cₜ,ś_{t+H}) (4)

Although the conditional component 116 may augment the policy with stochastic components, the short-term goals may reduce the uncertainty in the predictions. For instance, instead of directly regressing each state of an object's trajectory, the conditional component 116 may predict the controls (e.g., velocity, direction of travel, etc.) at each future time step and forward integrate the controls through the object's dynamic model.

The process 100 may include inputting at least a portion of the input data 106 and/or state data 120 associated with the objects into a prediction component 122 that is trained to generate data 124 (also referred to, in some examples, as “trajectory data 124”) representing predicted trajectories of nearby objects over the given period of time. In some examples, the state data 120 may represent the current states of the objects at a time that corresponds to the given instance of time associated with the map data 108. The current state associated with an object may include, but is not limited to, a location of the object, a velocity of the object, an acceleration of the object, a direction of travel of the object, and/or any other state information. As such, the actions data 118 may represent one or more actions (e.g., one or more trajectories) that an object may navigate over the given period of time, while the trajectory data 124 represents the predicted trajectories that nearby objects may navigate over the given period of time.

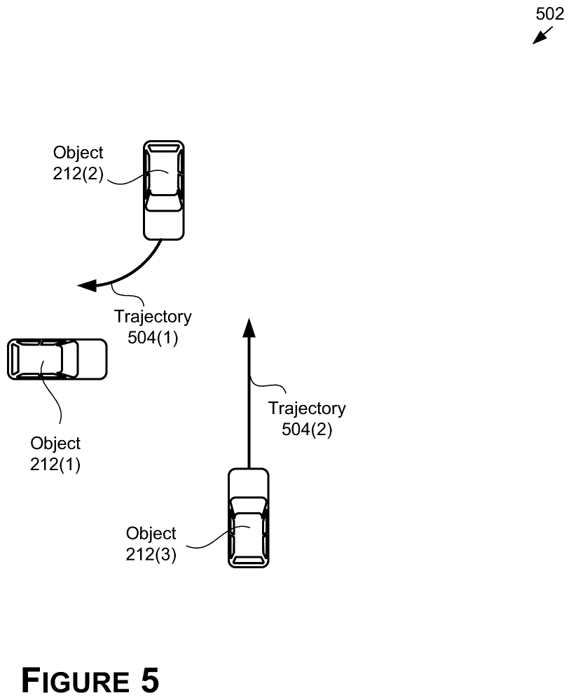

For instance, FIG. 5 illustrates an example of trajectory data 502 (which may represent, and/or include, the trajectory data 124) representing predicted trajectories 504(1)-(2) (also referred to singularly as “predicted trajectory 504” or in plural as “predicted trajectories 504”) associated with nearby objects 212(2)-(3), in accordance with some embodiments of the present disclosure. As shown, the prediction component 122 may determine that the predicted trajectory 504(1) for the second object 212(2) includes the second object 212(2) navigating a right turn (e.g., onto the road 208(1)). The prediction component 122 may also determine that the predicted trajectory 504(2) for the third object 212(3) includes the third object 212(3) continuing to navigate straight (e.g., along the road 208(2). While the example of FIG. 5 illustrates the prediction component 122 only determining a single predicted trajectory 504 for each object 212(2)-(3), in other examples, the prediction component 122 may determine more than one predicted trajectory 504 for one or more of the object 212(2)-(3).

Additionally, while the example of FIG. 5 illustrates determining the predicted trajectories 504 for the objects 212(2)-(3), in other examples, the prediction component 122 may determine predicted trajectories for other objects. For a first example, if the conditional component 116 generates actions data 118 representing an action(s) that the second object 212(2) may navigate, then the prediction component 122 may generate trajectory data 124 representing predicted trajectories associated with the first object 212(1) and the third object 212(3). For a second example, if the conditional component 116 generates actions data 118 representing an action(s) that the third object 212(3) may navigate, then the prediction component 122 may generate trajectory data 124 representing predicted trajectories associated with the first object 212(1) and the second object 212(2).

Referring back to the example of FIG. 1, and for more detail, since the prediction component 122 may assume an analytical object dynamics model and known static map, the main stack of the prediction component 122 may be to predict the future motion trajectories of the nearby objects. As such, the prediction component 122 may follow a typical trajectory prediction pipeline and determine features for each object by the object's local and global scene context. Specifically, the prediction component 122 may use crops the features extracted by an intermediate layer of a neural network(s) (which is described in detail below). The per-object features may then be concatenated with a global scene context feature (e.g., extracted from the final layer of the neural network(s)) to make the final trajectory prediction s_{t:t+H}⁽ⁱ⁾ for each neighboring object i. The prediction component 122 may then use deterministic predictions and defer more sophisticated probabilistic predictions and planning

The process 100 may include inputting at least a portion of the actions data 118 and/or at least a portion of the trajectory data 124 into a selection component 126 that is configured to generate simulation data 128 representing one or more simulated trajectories. For instance, the selection component 126 may determine a respective cost associated with one or more (e.g., each) of the action(s) represented by the actions data 118. In some examples, the selection component 126 may use one or more rules when determining the cost(s), such as a collision rule that is associated with distances between the object and the other objects when navigating according to the action(s) and a road departure rule that is associated with whether the action(s) would cause the object to navigate outside of a drivable area (e.g., off the roads).

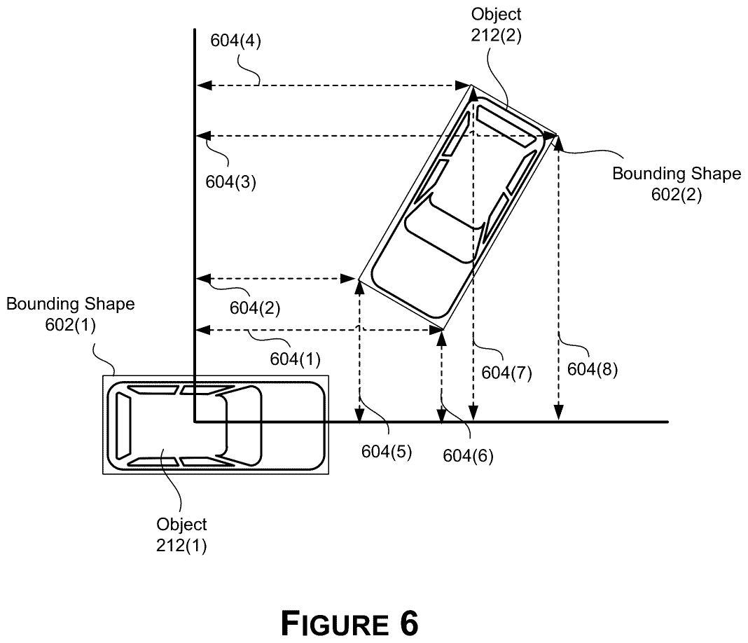

For instance, FIG. 6 illustrates an example of using a collision rule when determining a cost associated with an action, in accordance with some embodiments of the present disclosure. As shown, the selection component 126 may determine a first bounding shape 602(1) associated with the first object 212(1) and a second bounding shape 602(2) associated with the second object 212(2). The selection component 126 may then use the bounding shapes 602(1)-(2) to determine distances 604(1)-(8) (also referred to singularly as “distance 604” or in plural as “distances 604”) between the first object 212(1) and the second object 212(2). As shown, the distances 604(1)-(4) between the first object 212(1) and the corners of the bounding shape 602(2) associated with the second object 212(2) are in a first direction, such as an x-direction. Additionally, the distances 604(5)-(8) between the first object 212(1) and the corners of the bounding shape 602(2) associated with the second object 212(2) are in a second direction, such as a y-direction.

The selection component 126 may then use the distances 604 to compute the collision cost associated with the objects 212(1)-(2). For instance, the minimum distances may be approximated by:

$${d}_{m i n} ( Δ {X}_{1 : 4} , Δ {Y}_{1 : 4 ) ,} L , W = max \{ \begin{matrix}\vert Δ {X}_{1} \vert - \frac{L}{2} , … , \vert Δ {X}_{4} \vert - \frac{L}{2} \\ \vert Δ {Y}_{1} \vert - \frac{W}{2} , … , \vert Δ {Y}_{4} \vert - \frac{W}{2}\end{matrix} \} \qquad ( 5 )$$

In equation (5), L is the length of the bounding shape 602(1) and W is the width of the bounding shape 602(1). The following collision loss may then be added:

Col=Sigmoid(−αdₘᵢₙ−β) (6)

In equation (6), α and β are parameters used to shape the sigmoid loss. In some examples, α=1.0 and β=4.0. However, the parameters may include any other values in other examples.

Referring back to the example of FIG. 1, the selection component 126 may use a distance map (which may also be represented by the map data 108) that records distances to drivable areas, such as in pixels. The selection component 126 may then select a maximum distance constant D and set all pixels inside the drivable area to a number, such as 0, and all pixels outside of the drivable area to D. Then, the selection component 126 may perform the following convolution set D times:

x_{i,j}=min{x_{i,j},x_{i-1,j}+1,x_{i+1,j}+1,x_{i,j-1}+1,x_{i,j+1}+1} (7)

In equation (7), xᵢⱼ is the value at the i,j coordinate. The resulting distance map may then assign zero to points within the drivable area, with values increasing outside of the drivable area until saturating at D. The selection component 126 may then use the distance value as the penalty. To account for the size the object, the selection component 126 may perform RolAlign on the distance map with object patches that take the object's size and orientation into account. As such, the cost terms are close to zero (the collision loss may be nonzero due to the sigmoid function) for nominal trajectories, such as trajectories that do not result in collision and road departure, minimizing the effect on selecting among rule-following action samples.

The selection component 126 may then use the costs associated with the actions represented by the actions data 118 to select an action for simulating the object over the given period of time. For instance, the selection component 126 may select the action associated with the highest cost, the action associated with the lowest cost, and/or any other action associated with any other cost. The selection component 126 may then perform similar processes in order to simulate trajectories associated with one or more (e.g., each) of the other objects. The output from the selection component 126 may then include simulation data 128 representing the simulated trajectories of the objects.

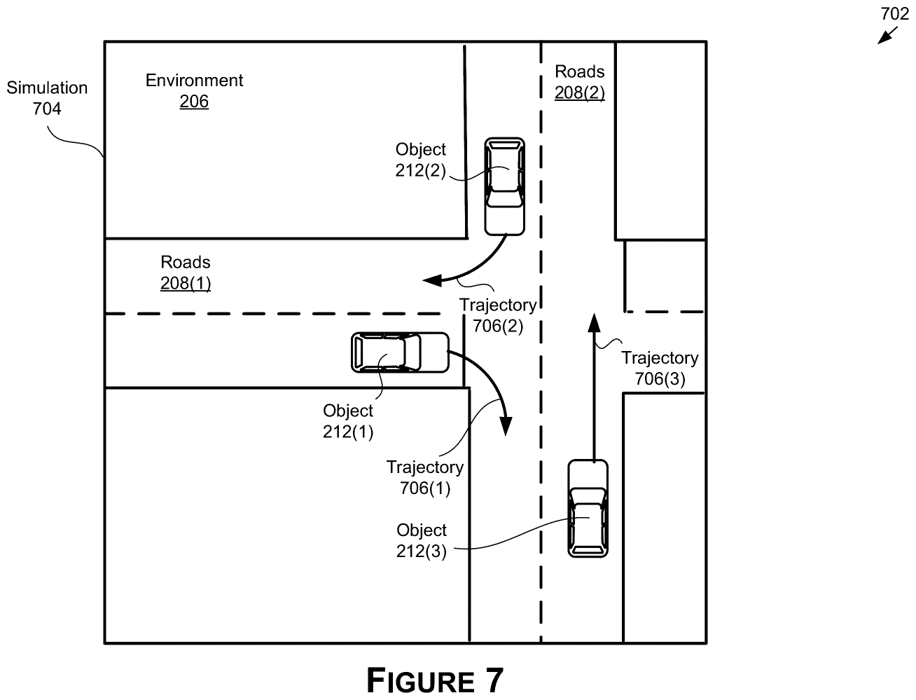

For instance, FIG. 7 illustrates an example of simulation data 702 (which may represent, and/or include, the simulation data 128) representing a simulation 704 of trajectories for the objects 212 within the environment 206, in accordance with some embodiments of the present disclosure. As shown, based on performing the process 100 for each of the objects 212, the simulation component 102 may determine at least a simulated trajectory 706(1) associated with the first object 212(1), a simulated trajectory 706(2) associated with the second object 212(2), and a simulated trajectory 706(3) associated with the third object 212(3). In the example of FIG. 7, the selection component 126 may have selected the third action 404(3) to include the simulated trajectory 706(1) for the first object 212(1) based on the costs associated with the actions 404.

Referring back to the example of FIG. 1, the simulation component 102 may continue to perform these processes, but with using at least a portion of the simulated trajectories represented by the simulation data 128, in order to continue to generate the simulation. For instance, and as described herein, the simulation component 102 may use current locations of the objects at a given instance in time (e.g., as represented by the map 204) and history information associated with the objects prior to the given instance in time (e.g., as represented by the history information 214) to determine these simulated trajectories (e.g., as represented by the simulation 704), where the simulated trajectories are over the given future period of time that is after the given instance in time. As such, the simulation component 102 may perform similar processes, but with updating the given instance of time, to continue extending the length of the simulation.

For example, the initial instance it time may be associated with time “0” seconds, the history information may be associated with a time interval of three seconds prior to the initial instance in time, such as between “−3” seconds are “0” seconds, and the given period of time may be associated with three seconds after the initial instance of time, such as between “0” seconds and “3” seconds (although these are only example time intervals and, in other examples, the simulation component 102 may use different time intervals). As such, when performing the process 100 again, the updated instance in time may include time “0.5” seconds, the history information may be associated with another time interval of three seconds prior to the updated instance in time, such as between “−2.5” seconds and “0.5” seconds, and the given period of time may again be associated with three seconds after the updated instance in time, such as between “0.5” seconds and “3.5” seconds. In such an example, the history information between “0” seconds and “0.5” seconds may come from the simulated trajectories (e.g., the simulated trajectories 706(1)-(3)) associated with the objects.

The simulation component 102 may then continue to perform these processes in order to continue determining the simulated trajectories for the objects. For instance, the simulation component 102 may continue to perform these processes until the simulated trajectories reach a threshold, such as a threshold time into the future (e.g., a threshold period of time after time “0” seconds in the example above,), a threshold distance (e.g., a threshold distance from the original locations of the objects at time “0” seconds in the example above), and/or the like. By performing such processes to incrementally determine the simulated trajectories of the objects, the simulation component 102 may determine simulated trajectories that are stable and imitate realistic behaviors (e.g., driving behaviors) of objects.

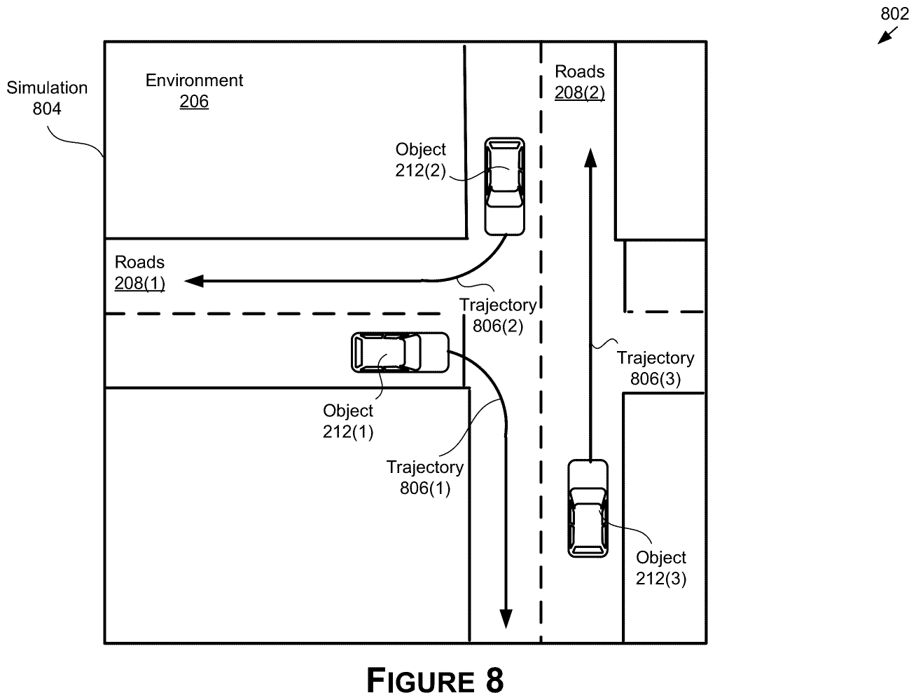

For instance, FIG. 8 illustrates an example of simulation data 802 (which may represent, and/or include, the simulation data 128) representing a simulation 804 of trajectories for the objects 212 within the environment 206, in accordance with some embodiments of the present disclosure. As shown, based on performing the process 100 for each of the objects 212 multiple times, the simulation component 102 may determine at least a simulated trajectory 806(1) associated with the first object 212(1), a simulated trajectory 806(2) associated with the second object 212(2), and a simulated trajectory 806(3) associated with the third object 212(3). As further shown by the example of FIG. 8, the simulated trajectories 806(1)-(3) extend further into a future time period as compared to the simulated trajectories 706(1)-(3) since, with each instance of performing the process 100, the simulation component 102 may extend the simulated trajectories further into the future.

Referring back to the example of FIG. 1, the simulation component 102 may also perform the process 100 of FIG. 1 multiple times, with using the same initial input data 106, in order to generate multiple simulations associated with the same objects within the same environment. In some examples, by performing the process 100 multiple times, the simulation component 102 may generate a diverse number of simulations since one or more (e.g., each) of the simulations may at least partially differ from one another each time that the simulation component 102 generates a respective simulation.

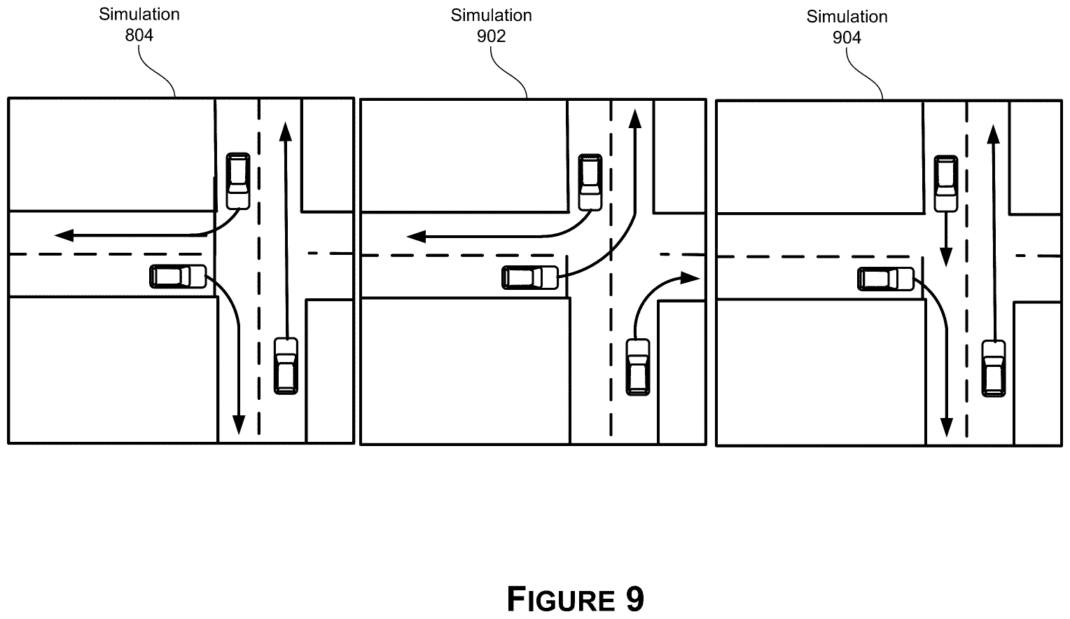

For instance, FIG. 9 illustrates examples of generating diverse simulations, in accordance with some embodiments of the present disclosure. As shown, the simulation component 102 may initially perform the process 100 a first time in order to generate the simulation 804 from the example of FIG. 8. The simulation component 102 may then again perform the process 100 a second time to generate a simulation 902 and perform the process 100 a third time to generate the simulation 904. As shown, each of the simulation 804, the simulation 902, and the simulation 904 differ from one another in the simulation trajectories of the objects 212. While the example of FIG. 9 illustrates generating three different simulations using the input data 106, in other examples, the simulation component 102 may generate any number of simulations (e.g., one simulation, five simulations, ten simulations, fifty simulations, etc.) using the input data 106.

In some examples, the simulation component 102 may use one or more metrics for evaluating the simulations. The metric(s) may include, but is not limited to, (1) a metric measuring how much simulated objects violate common traffic rules, such as driving offroad or causing collisions with other objects, (2) a metric measuring the statistics of simulation rollouts, including the resemblance to collected driving logs in terms of driving characteristics such as speed profile, control effort, coverage of the driving area, and behavior diversity between different simulations, and (3) a metric learned from real-world driving logs, such as measuring the likelihood of simulation rollouts under data-driven trajectory forecasting models.

For example, to calculate how much an environment is covered by the objects, the simulation component 102 may first compute the simulator's trajectory distribution, such as by using a Density Estimation with a Gaussian kernel, over one or more (e.g., all) timesteps of the simulator's rollouts, focusing on the 2D spatial distribution of the trajectory. To measure the coverage of the map, the simulation component 102 may count the number of grid points where the estimate is above a threshold, separating the count between drivable areas and non-drivable areas. To measure the diversity of stochastic policies, the simulation component 102 may execute multiple trials with the same initial condition and collect the density estimates for each trial. Given two different trials, the simulation component 102 may compute a distance (e.g., the Wasserstein distance) between the two density profiles. In particular, all grid points with non-zero density are flattened, and a distance matrix is computed containing the Euclidean distances between every pair of grid points. The density profile is then normalized to sum to 1 and the distance may be computed efficiently. For n trials of the same environment, the simulation component 102 may calculate the distances between the n(n−1)/2 pairs of density profiles and take the mean as the metric for diversity. For instance, the following equation may be used:

$$Diversity = \frac{2}{n ( n - 1 )} {\sum }_{i = 1}^{n - 1} {\sum }_{j = i + 1}^{n} Wass ( {p}_{i} , {p}_{j} ) \qquad ( 8 )$$

In equation (8), Wass(⋅,⋅) is the Wasserstein distance and pᵢ is the density profile for the i-th trial.

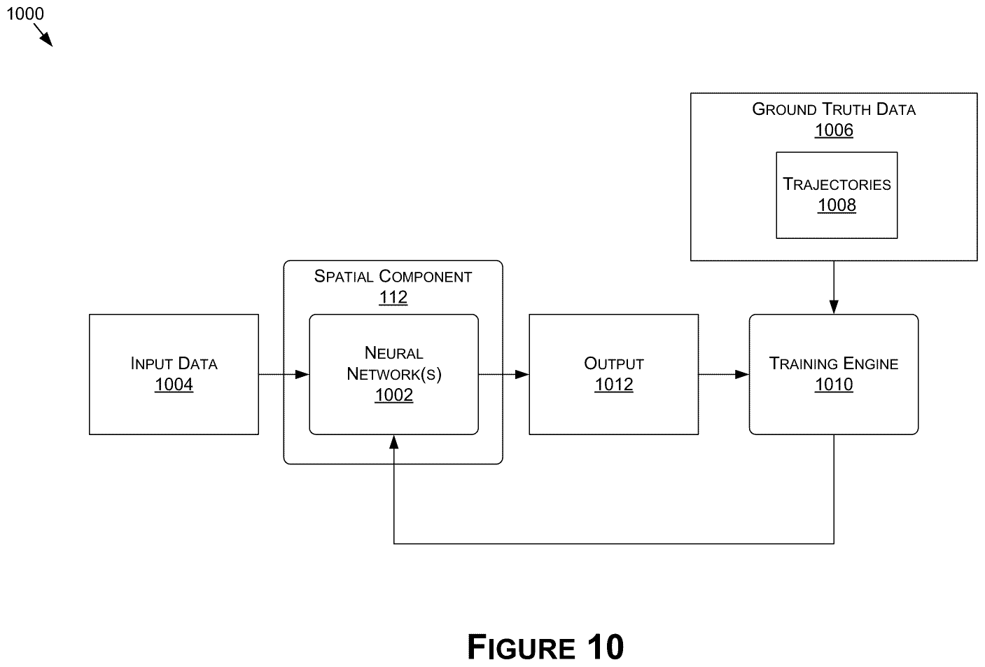

As described herein, the spatial component 112, the conditional component 116, and/or the prediction component 122 may be trained to generate specific types of data. As such, FIG. 10 is a data flow diagram illustrating a process 1000 for training the spatial component 112, in accordance with some examples of the present disclosure. As shown, a neural network(s) 1002 associated with the spatial component 112 may be trained using input data 1004. The input data 1004 may include at least a portion of log data, such as the log data 104. In some examples, the input data 1004 may also be similar to the input data 106 that is later processed by the spatial component 112. For example, the input data 1004 may include map data representing one or more maps and/or history data representing history information associated with objects.

The neural network(s) 1002 may be trained using the input data 1004 as well as corresponding ground truth data 1006. The ground truth data 1006 may include annotations, labels, masks, and/or the like. For instance, in some examples, the ground truth data 1006 may include actual trajectories 1008 that objects navigated within the environments. The ground truth data 1006 may be generated within a drawing program (e.g., an annotation program), a computer aided design (CAD) program, a labeling program, another type of program suitable for generating the ground truth data 1006, and/or may be hand drawn, in some examples. In any example, the ground truth data 1006 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer). In some examples, the ground truth data 1006 is generated using the log data.

A training engine 1010 may include one or more loss functions that measure loss (e.g., error) in the outputs 1012 as compared to the ground truth data 1006. Any type of loss function may be used, such as cross entropy loss, mean squared error, mean absolute error, mean bias error, and/or other loss function types. In some examples, different outputs 1012 may have different loss functions. In such examples, the loss functions may be combined to form a total loss, and the total loss may be used to train (e.g., update the parameters of) the neural network(s) 1002. In any example, backward pass computations may be performed to recursively compute gradients of the loss function(s) with respect to training parameters. In some examples, weight and biases of the neural network(s) 1002 may be used to compute these gradients.

For instance, and as described herein, the spatial component 112 may output a 2D grid goal likelihood as well as residual components to refine the predicted goal location. For example, the output 1012 may include a tensor with a given number of channels (e.g., 2-channel, 4-channel, etc.). As such, in some examples, such as when the tensor includes 4 channels, channel 0 is the likelihood of the coarse goal location 2D probability map, each pixel in channel 1 and channel 2 is the (x, y) scalar residual relative to the grid location, and channel 3 is the direction of travel prediction at each grid location. The training engine 1010 may thus treat the 2D location map as a joint distribution and train using cross-entropy loss across locations. Additionally, the training engine 1010 may train the other channels with masked regression losses (e.g., squared error).

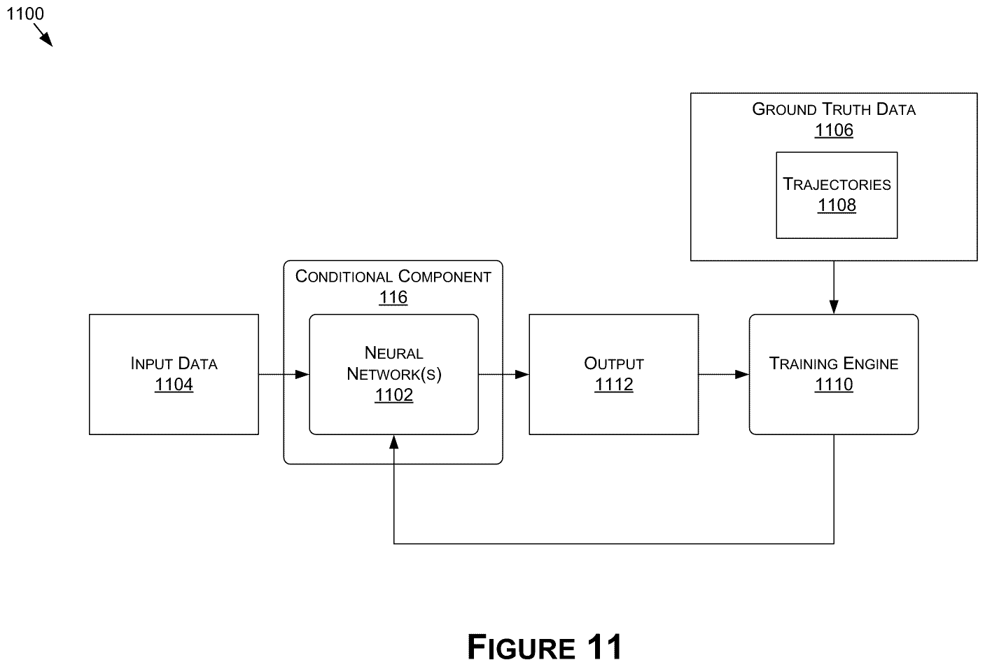

FIG. 11 is a data flow diagram illustrating a process 1100 for training the conditional component 116, in accordance with some examples of the present disclosure. As shown, a neural network(s) 1102 associated with the conditional component 116 may be trained using input data 1104. The input data 1104 may include at least a portion of log data, such as the log data 104. In some examples, the input data 1104 may also be similar to the input data 106 that is later processed by the conditional component 116. For example, the input data 1104 may include map data representing one or more maps and/or history data representing history information associated with objects. In some examples, the input data 1104 may further include goals data generated by the spatial component 112, such as similar to the goals data 114.

The neural network(s) 1102 may be trained using the input data 1104 as well as corresponding ground truth data 1106. The ground truth data 1106 may include annotations, labels, masks, and/or the like. For instance, in some examples, the ground truth data 1106 may include actual trajectories 1108 that objects navigated within the environments. The ground truth data 1106 may be generated within a drawing program (e.g., an annotation program), a computer aided design (CAD) program, a labeling program, another type of program suitable for generating the ground truth data 1106, and/or may be hand drawn, in some examples. In any example, the ground truth data 1106 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer). In some examples, the ground truth data 1106 is generated using the log data.

A training engine 1110 may include one or more loss functions that measure loss (e.g., error) in the outputs 1112 as compared to the ground truth data 1106. Any type of loss function may be used, such as cross entropy loss, mean squared error, mean absolute error, mean bias error, and/or other loss function types. In some examples, different outputs 1112 may have different loss functions. In such examples, the loss functions may be combined to form a total loss, and the total loss may be used to train (e.g., update the parameters of) the neural network(s) 1102. In any example, backward pass computations may be performed to recursively compute gradients of the loss function(s) with respect to training parameters. In some examples, weight and biases of the neural network(s) 1102 may be used to compute these gradients.

For examples, the training engine 1110 may determine errors between the predicted trajectories (e.g., the predicted actions) represented by the output 1112 and the reference trajectories 1108 represented by the ground truth data 1106. The training engine 1110 may then perform backward pass computations directly through the neural network(s) 1102 based on the errors.

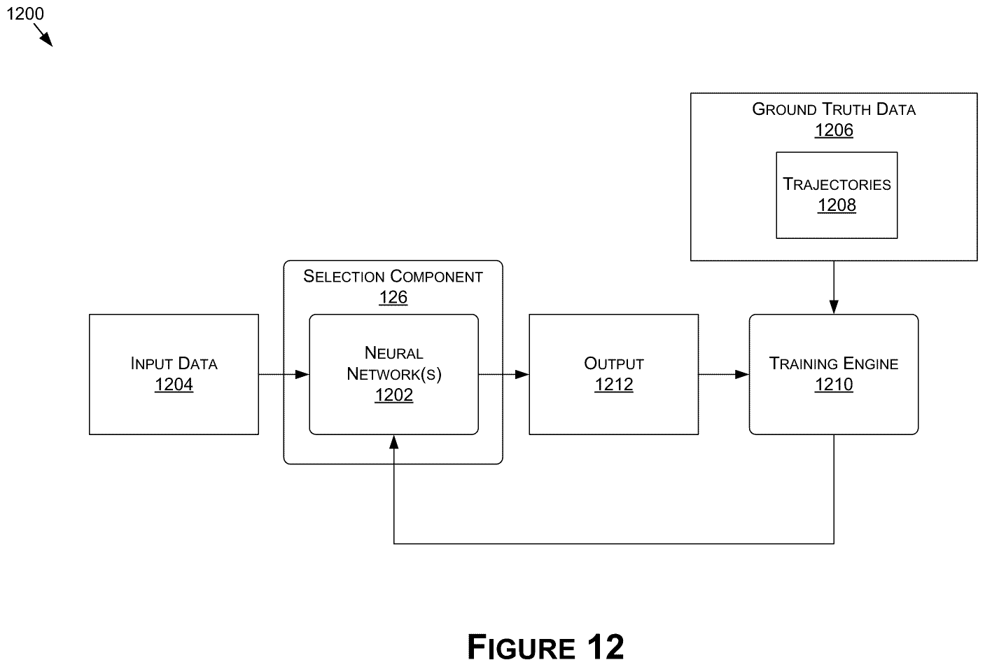

FIG. 12 is a data flow diagram illustrating a process 1200 for training the prediction component 122, in accordance with some examples of the present disclosure. As shown, a neural network(s) 1202 associated with the prediction component 122 may be trained using input data 1204. The input data 1204 may include at least a portion of log data, such as the log data 104. In some examples, the input data 1204 may also be similar to the input data 106 that is later processed by the prediction component 122. For example, the input data 1204 may include map data representing one or more maps and/or history data representing history information associated with objects. In some examples, the input data 1204 may further include state data, such as similar to the state data 120.

The neural network(s) 1202 may be trained using the input data 1204 as well as corresponding ground truth data 1206. The ground truth data 1206 may include annotations, labels, masks, and/or the like. For instance, in some examples, the ground truth data 1206 may include actual trajectories 1208 that objects navigated within the environments. The ground truth data 1206 may be generated within a drawing program (e.g., an annotation program), a computer aided design (CAD) program, a labeling program, another type of program suitable for generating the ground truth data 1206, and/or may be hand drawn, in some examples. In any example, the ground truth data 1206 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer). In some examples, the ground truth data 1206 is generated using the log data.

A training engine 1210 may include one or more loss functions that measure loss (e.g., error) in the outputs 1212 as compared to the ground truth data 1206. Any type of loss function may be used, such as cross entropy loss, mean squared error, mean absolute error, mean bias error, and/or other loss function types. In some examples, different outputs 1212 may have different loss functions. In such examples, the loss functions may be combined to form a total loss, and the total loss may be used to train (e.g., update the parameters of) the neural network(s) 1202. In any example, backward pass computations may be performed to recursively compute gradients of the loss function(s) with respect to training parameters. In some examples, weight and biases of the neural network(s) 1202 may be used to compute these gradients.

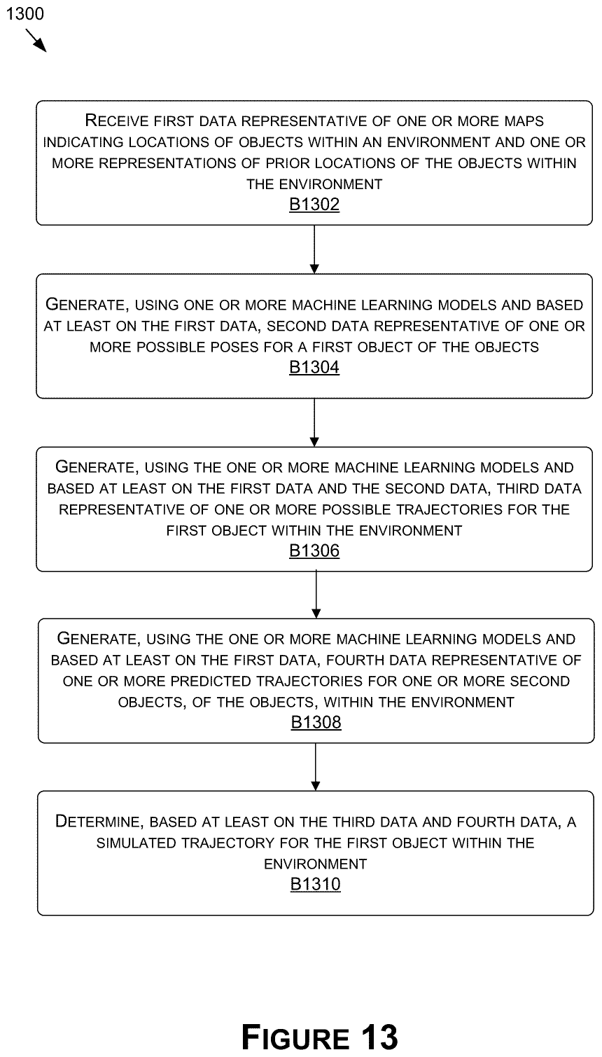

Now referring to FIG. 13, each block of method 1300, described herein, comprises a computing process that may be performed using any combination of hardware, firmware, and/or software. For instance, various functions may be carried out by a processor executing instructions stored in memory. The method 1300 may also be embodied as computer-usable instructions stored on computer storage media. The method 1300 may be provided by a standalone application, a service or hosted service (standalone or in combination with another hosted service), or a plug-in to another product, to name a few. In addition, the method 1300 is described, by way of example, with respect to FIG. 1. However, the method 1300 may additionally or alternatively be executed by any one system, or any combination of systems, including, but not limited to, those described herein.

FIG. 13 is a flow diagram showing a method 1300 for generating a simulation associated with objects, in accordance with some embodiments of the present disclosure. The method 1300, at block B1302, may include receiving first data representative of one or more maps indicating locations of objects within an environment and one or more representations of prior locations of the objects within the environment. For instance, the simulation component 102 may receive and/or generate the input data 106, where the input data 106 includes at least the map data 108 representing the one or more maps indicating the locations of the objects within the environment and the history data 110 representing the prior locations of the objects within the environment.

The method 1300, at block B1304, may include generating, using one or more machine learning models and based at least on the first data, second data representative of one or more possible poses for a first object of the objects. For instance, the simulation component 102 may input the input data 106 into a first machine learning model(s) associated with the spatial component 112. The spatial component 112 may then process the input data 106 using the first machine learning model(s) and, based on the processing, output the goals data 114. As described herein, the goals data 114 may represent one or more navigational goals associated with the first object within the environment. For instance, the goals data 114 may represent the one or more poses (e.g., one or more locations, one or more directions of travel, etc.) associated with the first object at a future time.

The method 1300, at block B1306, may include generating, using the one or more machine learning models and based at least on the first data and the second data, third data representative of one or more possible trajectories for the first object within the environment. For instance, the simulation component 102 may input the input data 106 and the goals data 114 into a second machine learning model(s) associated with the conditional component 116. The conditional component 116 may then process the input data 106 and the actions data 118 using the second machine learning model(s) and, based on the processing, output the actions data 118. As described herein, the actions data 118 may represent one or more actions (e.g., the one or more possible trajectories) for the first object within the environment.

The method 1300, at block B1308, may include generating, using the one or more machine learning models and based at least on the first data, fourth data representative of one or more predicted trajectories for one or more second objects, of the objects, within the environment. For instance, the simulation component 102 may input the input data 106 and/or the state data 120 into a third machine learning model(s) associated with the prediction component 122. The prediction component 122 may then process the input data 106 and/or the state data 120 using the third machine learning model(s) and, based on the processing, output the trajectory data 124. As described herein, the trajectory data 124 may represent the one or more predicted trajectories of the one or more second objects.

The method 1300, at block B1310, may include determining, based at least on the third data and the fourth data, a simulated trajectory for the first object within the environment. For instance, the simulation component 102 may use a selection component 126 to process the actions data 118 and the trajectory data 124. The selection component 126 may then generate, based on processing the actions data 118 and the trajectory data 124 (using one or more of the processes described herein), the simulation data 128 representing the simulated trajectory of the first object within the environment. As described herein, the simulated trajectory may include one of the possible trajectories represented by the actions data 118.

### Example Autonomous Vehicle

FIG. 14A is an illustration of an example autonomous vehicle 1400, in accordance with some embodiments of the present disclosure. The autonomous vehicle 1400 (alternatively referred to herein as the “vehicle 1400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1400 may be capable of functionality in accordance with one or more of Level 3-Level 5 of the autonomous driving levels. The vehicle 1400 may be capable of functionality in accordance with one or more of Level 1-Level 5 of the autonomous driving levels. For example, the vehicle 1400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1400 or other machine, such as being fully autonomous, being highly autonomous, being conditionally autonomous, being partially autonomous, providing assistive autonomy, being semi-autonomous, being primarily autonomous, or other designation.

The vehicle 1400 may include components such as a chassis, a vehicle body, wheels (e.g., 2, 4, 6, 8, 18, etc.), tires, axles, and other components of a vehicle. The vehicle 1400 may include a propulsion system 1450, such as an internal combustion engine, hybrid electric power plant, an all-electric engine, and/or another propulsion system type. The propulsion system 1450 may be connected to a drive train of the vehicle 1400, which may include a transmission, to enable the propulsion of the vehicle 1400. The propulsion system 1450 may be controlled in response to receiving signals from the throttle/accelerator 1452.

A steering system 1454, which may include a steering wheel, may be used to steer the vehicle 1400 (e.g., along a desired path or route) when the propulsion system 1450 is operating (e.g., when the vehicle is in motion). The steering system 1454 may receive signals from a steering actuator 1456. The steering wheel may be optional for full automation (Level 5) functionality.

The brake sensor system 1446 may be used to operate the vehicle brakes in response to receiving signals from the brake actuators 1448 and/or brake sensors.

Controller(s) 1436, which may include one or more system on chips (SoCs) 1404 (FIG. 14C) and/or GPU(s), may provide signals (e.g., representative of commands) to one or more components and/or systems of the vehicle 1400. For example, the controller(s) may send signals to operate the vehicle brakes via one or more brake actuators 1448, to operate the steering system 1454 via one or more steering actuators 1456, to operate the propulsion system 1450 via one or more throttle/accelerators 1452. The controller(s) 1436 may include one or more onboard (e.g., integrated) computing devices (e.g., supercomputers) that process sensor signals, and output operation commands (e.g., signals representing commands) to enable autonomous driving and/or to assist a human driver in driving the vehicle 1400. The controller(s) 1436 may include a first controller 1436 for autonomous driving functions, a second controller 1436 for functional safety functions, a third controller 1436 for artificial intelligence functionality (e.g., computer vision), a fourth controller 1436 for infotainment functionality, a fifth controller 1436 for redundancy in emergency conditions, and/or other controllers. In some examples, a single controller 1436 may handle two or more of the above functionalities, two or more controllers 1436 may handle a single functionality, and/or any combination thereof.

The controller(s) 1436 may provide the signals for controlling one or more components and/or systems of the vehicle 1400 in response to sensor data received from one or more sensors (e.g., sensor inputs). The sensor data may be received from, for example and without limitation, global navigation satellite systems (“GNSS”) sensor(s) 1458 (e.g., Global Positioning System sensor(s)), RADAR sensor(s) 1460, ultrasonic sensor(s) 1462, LIDAR sensor(s) 1464, inertial measurement unit (IMU) sensor(s) 1466 (e.g., accelerometer(s), gyroscope(s), magnetic compass(es), magnetometer(s), etc.), microphone(s) 1496, stereo camera(s) 1468, wide-view camera(s) 1470 (e.g., fisheye cameras), infrared camera(s) 1472, surround camera(s) 1474 (e.g., 360 degree cameras), long-range and/or mid-range camera(s) 1498, speed sensor(s) 1444 (e.g., for measuring the speed of the vehicle 1400), vibration sensor(s) 1442, steering sensor(s) 1440, brake sensor(s) (e.g., as part of the brake sensor system 1446), and/or other sensor types.

One or more of the controller(s) 1436 may receive inputs (e.g., represented by input data) from an instrument cluster 1432 of the vehicle 1400 and provide outputs (e.g., represented by output data, display data, etc.) via a human-machine interface (HMI) display 1434, an audible annunciator, a loudspeaker, and/or via other components of the vehicle 1400. The outputs may include information such as vehicle velocity, speed, time, map data (e.g., the High Definition (“HD”) map 1422 of FIG. 14C), location data (e.g., the vehicle's 1400 location, such as on a map), direction, location of other vehicles (e.g., an occupancy grid), information about objects and status of objects as perceived by the controller(s) 1436, etc. For example, the HMI display 1434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1400 further includes a network interface 1424 which may use one or more wireless antenna(s) 1426 and/or modem(s) to communicate over one or more networks. For example, the network interface 1424 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1426 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 14B is an example of camera locations and fields of view for the example autonomous vehicle 1400 of FIG. 14A, in accordance with some embodiments of the present disclosure. The cameras and respective fields of view are one example embodiment and are not intended to be limiting. For example, additional and/or alternative cameras may be included and/or the cameras may be located at different locations on the vehicle 1400.

The camera types for the cameras may include, but are not limited to, digital cameras that may be adapted for use with the components and/or systems of the vehicle 1400. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1400 (e.g., front-facing cameras) may be used for surround view, to help identify forward facing paths and obstacles, as well aid in, with the help of one or more controllers 1436 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1470 that may be used to perceive objects coming into view from the periphery (e.g., pedestrians, crossing traffic or bicycles). Although only one wide-view camera is illustrated in FIG. 14B, there may be any number (including zero) of wide-view cameras 1470 on the vehicle 1400. In addition, any number of long-range camera(s) 1498 (e.g., a long-view stereo camera pair) may be used for depth-based object detection, especially for objects for which a neural network has not yet been trained. The long-range camera(s) 1498 may also be used for object detection and classification, as well as basic object tracking.

Any number of stereo cameras 1468 may also be included in a front-facing configuration. In at least one embodiment, one or more of stereo camera(s) 1468 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1468 may be used in addition to, or alternatively from, those described herein.

Cameras with a field of view that include portions of the environment to the side of the vehicle 1400 (e.g., side-view cameras) may be used for surround view, providing information used to create and update the occupancy grid, as well as to generate side impact collision warnings. For example, surround camera(s) 1474 (e.g., four surround cameras 1474 as illustrated in FIG. 14B) may be positioned to on the vehicle 1400. The surround camera(s) 1474 may include wide-view camera(s) 1470, fisheye camera(s), 360 degree camera(s), and/or the like. Four example, four fisheye cameras may be positioned on the vehicle's front, rear, and sides. In an alternative arrangement, the vehicle may use three surround camera(s) 1474 (e.g., left, right, and rear), and may leverage one or more other camera(s) (e.g., a forward-facing camera) as a fourth surround view camera.

Cameras with a field of view that include portions of the environment to the rear of the vehicle 1400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1498, stereo camera(s) 1468), infrared camera(s) 1472, etc.), as described herein.

FIG. 14C is a block diagram of an example system architecture for the example autonomous vehicle 1400 of FIG. 14A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1400 in FIG. 14C are illustrated as being connected via bus 1402. The bus 1402 may include a Controller Area Network (CAN) data interface (alternatively referred to herein as a “CAN bus”). A CAN may be a network inside the vehicle 1400 used to aid in control of various features and functionality of the vehicle 1400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1402 is described herein as being a CAN bus, this is not intended to be limiting. For example, in addition to, or alternatively from, the CAN bus, FlexRay and/or Ethernet may be used. Additionally, although a single line is used to represent the bus 1402, this is not intended to be limiting. For example, there may be any number of busses 1402, which may include one or more CAN busses, one or more FlexRay busses, one or more Ethernet busses, and/or one or more other types of busses using a different protocol. In some examples, two or more busses 1402 may be used to perform different functions, and/or may be used for redundancy. For example, a first bus 1402 may be used for collision avoidance functionality and a second bus 1402 may be used for actuation control. In any example, each bus 1402 may communicate with any of the components of the vehicle 1400, and two or more busses 1402 may communicate with the same components. In some examples, each SoC 1404, each controller 1436, and/or each computer within the vehicle may have access to the same input data (e.g., inputs from sensors of the vehicle 1400), and may be connected to a common bus, such the CAN bus.

The vehicle 1400 may include one or more controller(s) 1436, such as those described herein with respect to FIG. 14A. The controller(s) 1436 may be used for a variety of functions. The controller(s) 1436 may be coupled to any of the various other components and systems of the vehicle 1400, and may be used for control of the vehicle 1400, artificial intelligence of the vehicle 1400, infotainment for the vehicle 1400, and/or the like.

The vehicle 1400 may include a system(s) on a chip (SoC) 1404. The SoC 1404 may include CPU(s) 1406, GPU(s) 1408, processor(s) 1410, cache(s) 1412, accelerator(s) 1414, data store(s) 1416, and/or other components and features not illustrated. The SoC(s) 1404 may be used to control the vehicle 1400 in a variety of platforms and systems. For example, the SoC(s) 1404 may be combined in a system (e.g., the system of the vehicle 1400) with an HD map 1422 which may obtain map refreshes and/or updates via a network interface 1424 from one or more servers (e.g., server(s) 1478 of FIG. 14D).

The CPU(s) 1406 may include a CPU cluster or CPU complex (alternatively referred to herein as a “CCPLEX”). The CPU(s) 1406 may include multiple cores and/or L2 caches. For example, in some embodiments, the CPU(s) 1406 may include eight cores in a coherent multi-processor configuration. In some embodiments, the CPU(s) 1406 may include four dual-core clusters where each cluster has a dedicated L2 cache (e.g., a 2 MB L2 cache). The CPU(s) 1406 (e.g., the CCPLEX) may be configured to support simultaneous cluster operation enabling any combination of the clusters of the CPU(s) 1406 to be active at any given time.

The CPU(s) 1406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1408 may include an integrated GPU (alternatively referred to herein as an “iGPU”). The GPU(s) 1408 may be programmable and may be efficient for parallel workloads. The GPU(s) 1408, in some examples, may use an enhanced tensor instruction set. The GPU(s) 1408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1408 may include at least eight streaming microprocessors. The GPU(s) 1408 may use compute application programming interface(s) (API(s)). In addition, the GPU(s) 1408 may use one or more parallel computing platforms and/or programming models (e.g., NVIDIA's CUDA).

The GPU(s) 1408 may be power-optimized for best performance in automotive and embedded use cases. For example, the GPU(s) 1408 may be fabricated on a Fin field-effect transistor (FinFET). However, this is not intended to be limiting and the GPU(s) 1408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1408 to access the CPU(s) 1406 page tables directly. In such examples, when the GPU(s) 1408 memory management unit (MMU) experiences a miss, an address translation request may be transmitted to the CPU(s) 1406. In response, the CPU(s) 1406 may look in its page tables for the virtual-to-physical mapping for the address and transmits the translation back to the GPU(s) 1408. As such, unified memory technology may allow a single unified virtual address space for memory of both the CPU(s) 1406 and the GPU(s) 1408, thereby simplifying the GPU(s) 1408 programming and porting of applications to the GPU(s) 1408.

In addition, the GPU(s) 1408 may include an access counter that may keep track of the frequency of access of the GPU(s) 1408 to memory of other processors. The access counter may help ensure that memory pages are moved to the physical memory of the processor that is accessing the pages most frequently.

The SoC(s) 1404 may include any number of cache(s) 1412, including those described herein. For example, the cache(s) 1412 may include an L3 cache that is available to both the CPU(s) 1406 and the GPU(s) 1408 (e.g., that is connected both the CPU(s) 1406 and the GPU(s) 1408). The cache(s) 1412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1404 may include an arithmetic logic unit(s) (ALU(s)) which may be leveraged in performing processing with respect to any of the variety of tasks or operations of the vehicle 1400—such as processing DNNs. In addition, the SoC(s) 1404 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1406 and/or GPU(s) 1408.

The SoC(s) 1404 may include one or more accelerators 1414 (e.g., hardware accelerators, software accelerators, or a combination thereof). For example, the SoC(s) 1404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1408 and to off-load some of the tasks of the GPU(s) 1408 (e.g., to free up more cycles of the GPU(s) 1408 for performing other tasks). As an example, the accelerator(s) 1414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1408, and by using an inference accelerator, for example, a designer may target either the DLA(s) or the GPU(s) 1408 for any function. For example, the designer may focus processing of CNNs and floating point operations on the DLA(s) and leave other functions to the GPU(s) 1408 and/or other accelerator(s) 1414.

The accelerator(s) 1414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1414 (e.g., the hardware acceleration cluster) may include a computer vision network on-chip and SRAM, for providing a high-bandwidth, low latency SRAM for the accelerator(s) 1414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1466 output that correlates with the vehicle 1400 orientation, distance, 3D location estimates of the object obtained from the neural network and/or other sensors (e.g., LIDAR sensor(s) 1464 or RADAR sensor(s) 1460), among others.

The SoC(s) 1404 may include data store(s) 1416 (e.g., memory). The data store(s) 1416 may be on-chip memory of the SoC(s) 1404, which may store neural networks to be executed on the GPU and/or the DLA. In some examples, the data store(s) 1416 may be large enough in capacity to store multiple instances of neural networks for redundancy and safety. The data store(s) 1412 may comprise L2 or L3 cache(s) 1412. Reference to the data store(s) 1416 may include reference to the memory associated with the PVA, DLA, and/or other accelerator(s) 1414, as described herein.

The SoC(s) 1404 may include one or more processor(s) 1410 (e.g., embedded processors). The processor(s) 1410 may include a boot and power management processor that may be a dedicated processor and subsystem to handle boot power and management functions and related security enforcement. The boot and power management processor may be a part of the SoC(s) 1404 boot sequence and may provide runtime power management services. The boot power and management processor may provide clock and voltage programming, assistance in system low power state transitions, management of SoC(s) 1404 thermals and temperature sensors, and/or management of the SoC(s) 1404 power states. Each temperature sensor may be implemented as a ring-oscillator whose output frequency is proportional to temperature, and the SoC(s) 1404 may use the ring-oscillators to detect temperatures of the CPU(s) 1406, GPU(s) 1408, and/or accelerator(s) 1414. If temperatures are determined to exceed a threshold, the boot and power management processor may enter a temperature fault routine and put the SoC(s) 1404 into a lower power state and/or put the vehicle 1400 into a chauffeur to safe stop mode (e.g., bring the vehicle 1400 to a safe stop).

The processor(s) 1410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1410 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1410 may further include a real-time camera engine that may include a dedicated processor subsystem for handling real-time camera management.

The processor(s) 1410 may further include a high-dynamic range signal processor that may include an image signal processor that is a hardware engine that is part of the camera processing pipeline.

The processor(s) 1410 may include a video image compositor that may be a processing block (e.g., implemented on a microprocessor) that implements video post-processing functions needed by a video playback application to produce the final image for the player window. The video image compositor may perform lens distortion correction on wide-view camera(s) 1470, surround camera(s) 1474, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1408 is not required to continuously render new surfaces. Even when the GPU(s) 1408 is powered on and active doing 3D rendering, the video image compositor may be used to offload the GPU(s) 1408 to improve performance and responsiveness.

The SoC(s) 1404 may further include a mobile industry processor interface (MIPI) camera serial interface for receiving video and input from cameras, a high-speed interface, and/or a video input block that may be used for camera and related pixel input functions. The SoC(s) 1404 may further include an input/output controller(s) that may be controlled by software and may be used for receiving I/O signals that are uncommitted to a specific role.

The SoC(s) 1404 may further include a broad range of peripheral interfaces to enable communication with peripherals, audio codecs, power management, and/or other devices. The SoC(s) 1404 may be used to process data from cameras (e.g., connected over Gigabit Multimedia Serial Link and Ethernet), sensors (e.g., LIDAR sensor(s) 1464, RADAR sensor(s) 1460, etc. that may be connected over Ethernet), data from bus 1402 (e.g., speed of vehicle 1400, steering wheel position, etc.), data from GNSS sensor(s) 1458 (e.g., connected over Ethernet or CAN bus). The SoC(s) 1404 may further include dedicated high-performance mass storage controllers that may include their own DMA engines, and that may be used to free the CPU(s) 1406 from routine data management tasks.

The SoC(s) 1404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1404 may be faster, more reliable, and even more energy-efficient and space-efficient than conventional systems. For example, the accelerator(s) 1414, when combined with the CPU(s) 1406, the GPU(s) 1408, and the data store(s) 1416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1408.

In some examples, a CNN for facial recognition and vehicle owner identification may use data from camera sensors to identify the presence of an authorized driver and/or owner of the vehicle 1400. The always on sensor processing engine may be used to unlock the vehicle when the owner approaches the driver door and turn on the lights, and, in security mode, to disable the vehicle when the owner leaves the vehicle. In this way, the SoC(s) 1404 provide for security against theft and/or carjacking.

In another example, a CNN for emergency vehicle detection and identification may use data from microphones 1496 to detect and identify emergency vehicle sirens. In contrast to conventional systems, that use general classifiers to detect sirens and manually extract features, the SoC(s) 1404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1462, until the emergency vehicle(s) passes.

The vehicle may include a CPU(s) 1418 (e.g., discrete CPU(s), or dCPU(s)), that may be coupled to the SoC(s) 1404 via a high-speed interconnect (e.g., PCIe). The CPU(s) 1418 may include an X86 processor, for example. The CPU(s) 1418 may be used to perform any of a variety of functions, including arbitrating potentially inconsistent results between ADAS sensors and the SoC(s) 1404, and/or monitoring the status and health of the controller(s) 1436 and/or infotainment SoC 1430, for example.

The vehicle 1400 may include a GPU(s) 1420 (e.g., discrete GPU(s), or dGPU(s)), that may be coupled to the SoC(s) 1404 via a high-speed interconnect (e.g., NVIDIA's NVLINK). The GPU(s) 1420 may provide additional artificial intelligence functionality, such as by executing redundant and/or different neural networks, and may be used to train and/or update neural networks based on input (e.g., sensor data) from sensors of the vehicle 1400.

The vehicle 1400 may further include the network interface 1424 which may include one or more wireless antennas 1426 (e.g., one or more wireless antennas for different communication protocols, such as a cellular antenna, a Bluetooth antenna, etc.). The network interface 1424 may be used to enable wireless connectivity over the Internet with the cloud (e.g., with the server(s) 1478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1400 information about vehicles in proximity to the vehicle 1400 (e.g., vehicles in front of, on the side of, and/or behind the vehicle 1400). This functionality may be part of a cooperative adaptive cruise control functionality of the vehicle 1400.

The network interface 1424 may include a SoC that provides modulation and demodulation functionality and enables the controller(s) 1436 to communicate over wireless networks. The network interface 1424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1400 may further include data store(s) 1428 which may include off-chip (e.g., off the SoC(s) 1404) storage. The data store(s) 1428 may include one or more storage elements including RAM, SRAM, DRAM, VRAM, Flash, hard disks, and/or other components and/or devices that may store at least one bit of data.

The vehicle 1400 may further include GNSS sensor(s) 1458. The GNSS sensor(s) 1458 (e.g., GPS, assisted GPS sensors, differential GPS (DGPS) sensors, etc.), to assist in mapping, perception, occupancy grid generation, and/or path planning functions. Any number of GNSS sensor(s) 1458 may be used, including, for example and without limitation, a GPS using a USB connector with an Ethernet to Serial (RS-232) bridge.

The vehicle 1400 may further include RADAR sensor(s) 1460. The RADAR sensor(s) 1460 may be used by the vehicle 1400 for long-range vehicle detection, even in darkness and/or severe weather conditions. RADAR functional safety levels may be ASIL B. The RADAR sensor(s) 1460 may use the CAN and/or the bus 1402 (e.g., to transmit data generated by the RADAR sensor(s) 1460) for control and to access object tracking data, with access to Ethernet to access raw data in some examples. A wide variety of RADAR sensor types may be used. For example, and without limitation, the RADAR sensor(s) 1460 may be suitable for front, rear, and side RADAR use. In some example, Pulse Doppler RADAR sensor(s) are used.

The RADAR sensor(s) 1460 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1400 surroundings at higher speeds with minimal interference from traffic in adjacent lanes. The other two antennae may expand the field of view, making it possible to quickly detect vehicles entering or leaving the vehicle's 1400 lane.

Mid-range RADAR systems may include, as an example, a range of up to 1460 m (front) or 80 m (rear), and a field of view of up to 42 degrees (front) or 1450 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1400 may further include ultrasonic sensor(s) 1462. The ultrasonic sensor(s) 1462, which may be positioned at the front, back, and/or the sides of the vehicle 1400, may be used for park assist and/or to create and update an occupancy grid. A wide variety of ultrasonic sensor(s) 1462 may be used, and different ultrasonic sensor(s) 1462 may be used for different ranges of detection (e.g., 2.5 m, 4 m). The ultrasonic sensor(s) 1462 may operate at functional safety levels of ASIL B.

The vehicle 1400 may include LIDAR sensor(s) 1464. The LIDAR sensor(s) 1464 may be used for object and pedestrian detection, emergency braking, collision avoidance, and/or other functions. The LIDAR sensor(s) 1464 may be functional safety level ASIL B. In some examples, the vehicle 1400 may include multiple LIDAR sensors 1464 (e.g., two, four, six, etc.) that may use Ethernet (e.g., to provide data to a Gigabit Ethernet switch).

In some examples, the LIDAR sensor(s) 1464 may be capable of providing a list of objects and their distances for a 360-degree field of view. Commercially available LIDAR sensor(s) 1464 may have an advertised range of approximately 1400 m, with an accuracy of 2 cm-3 cm, and with support for a 1400 Mbps Ethernet connection, for example. In some examples, one or more non-protruding LIDAR sensors 1464 may be used. In such examples, the LIDAR sensor(s) 1464 may be implemented as a small device that may be embedded into the front, rear, sides, and/or corners of the vehicle 1400. The LIDAR sensor(s) 1464, in such examples, may provide up to a 120-degree horizontal and 35-degree vertical field-of-view, with a 200 m range even for low-reflectivity objects. Front-mounted LIDAR sensor(s) 1464 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1400. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1464 may be less susceptible to motion blur, vibration, and/or shock.

The vehicle may further include IMU sensor(s) 1466. The IMU sensor(s) 1466 may be located at a center of the rear axle of the vehicle 1400, in some examples. The IMU sensor(s) 1466 may include, for example and without limitation, an accelerometer(s), a magnetometer(s), a gyroscope(s), a magnetic compass(es), and/or other sensor types. In some examples, such as in six-axis applications, the IMU sensor(s) 1466 may include accelerometers and gyroscopes, while in nine-axis applications, the IMU sensor(s) 1466 may include accelerometers, gyroscopes, and magnetometers.

In some embodiments, the IMU sensor(s) 1466 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1466 may enable the vehicle 1400 to estimate heading without requiring input from a magnetic sensor by directly observing and correlating the changes in velocity from GPS to the IMU sensor(s) 1466. In some examples, the IMU sensor(s) 1466 and the GNSS sensor(s) 1458 may be combined in a single integrated unit.

The vehicle may include microphone(s) 1496 placed in and/or around the vehicle 1400. The microphone(s) 1496 may be used for emergency vehicle detection and identification, among other things.

The vehicle may further include any number of camera types, including stereo camera(s) 1468, wide-view camera(s) 1470, infrared camera(s) 1472, surround camera(s) 1474, long-range and/or mid-range camera(s) 1498, and/or other camera types. The cameras may be used to capture image data around an entire periphery of the vehicle 1400. The types of cameras used depends on the embodiments and requirements for the vehicle 1400, and any combination of camera types may be used to provide the necessary coverage around the vehicle 1400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 14A and FIG. 14B.

The vehicle 1400 may further include vibration sensor(s) 1442. The vibration sensor(s) 1442 may measure vibrations of components of the vehicle, such as the axle(s). For example, changes in vibrations may indicate a change in road surfaces. In another example, when two or more vibration sensors 1442 are used, the differences between the vibrations may be used to determine friction or slippage of the road surface (e.g., when the difference in vibration is between a power-driven axle and a freely rotating axle).

The vehicle 1400 may include an ADAS system 1438. The ADAS system 1438 may include a SoC, in some examples. The ADAS system 1438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1460, LIDAR sensor(s) 1464, and/or a camera(s). The ACC systems may include longitudinal ACC and/or lateral ACC. Longitudinal ACC monitors and controls the distance to the vehicle immediately ahead of the vehicle 1400 and automatically adjust the vehicle speed to maintain a safe distance from vehicles ahead. Lateral ACC performs distance keeping, and advises the vehicle 1400 to change lanes when necessary. Lateral ACC is related to other ADAS applications such as LCA and CWS.

CACC uses information from other vehicles that may be received via the network interface 1424 and/or the wireless antenna(s) 1426 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1400), while the I2V communication concept provides information about traffic further ahead. CACC systems may include either or both I2V and V2V information sources. Given the information of the vehicles ahead of the vehicle 1400, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1400 if the vehicle 1400 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1460, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1400 is backing up. Some RCTW systems include AEB to ensure that the vehicle brakes are applied to avoid a crash. RCTW systems may use one or more rear-facing RADAR sensor(s) 1460, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1400, the vehicle 1400 itself must, in the case of conflicting results, decide whether to heed the result from a primary computer or a secondary computer (e.g., a first controller 1436 or a second controller 1436). For example, in some embodiments, the ADAS system 1438 may be a backup and/or secondary computer for providing perception information to a backup computer rationality module. The backup computer rationality monitor may run a redundant diverse software on hardware components to detect faults in perception and dynamic driving tasks. Outputs from the ADAS system 1438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1404.

In other examples, ADAS system 1438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1438 may be fed into the primary computer's perception block and/or the primary computer's dynamic driving task block. For example, if the ADAS system 1438 indicates a forward crash warning due to an object immediately ahead, the perception block may use this information when identifying objects. In other examples, the secondary computer may have its own neural network which is trained and thus reduces the risk of false positives, as described herein.

The vehicle 1400 may further include the infotainment SoC 1430 (e.g., an in-vehicle infotainment system (IVI)). Although illustrated and described as a SoC, the infotainment system may not be a SoC, and may include two or more discrete components. The infotainment SoC 1430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1400. For example, the infotainment SoC 1430 may radios, disk players, navigation systems, video players, USB and Bluetooth connectivity, carputers, in-car entertainment, Wi-Fi, steering wheel audio controls, hands free voice control, a heads-up display (HUD), an HMI display 1434, a telematics device, a control panel (e.g., for controlling and/or interacting with various components, features, and/or systems), and/or other components. The infotainment SoC 1430 may further be used to provide information (e.g., visual and/or audible) to a user(s) of the vehicle, such as information from the ADAS system 1438, autonomous driving information such as planned vehicle maneuvers, trajectories, surrounding environment information (e.g., intersection information, vehicle information, road information, etc.), and/or other information.

The infotainment SoC 1430 may include GPU functionality. The infotainment SoC 1430 may communicate over the bus 1402 (e.g., CAN bus, Ethernet, etc.) with other devices, systems, and/or components of the vehicle 1400. In some examples, the infotainment SoC 1430 may be coupled to a supervisory MCU such that the GPU of the infotainment system may perform some self-driving functions in the event that the primary controller(s) 1436 (e.g., the primary and/or backup computers of the vehicle 1400) fail. In such an example, the infotainment SoC 1430 may put the vehicle 1400 into a chauffeur to safe stop mode, as described herein.

The vehicle 1400 may further include an instrument cluster 1432 (e.g., a digital dash, an electronic instrument cluster, a digital instrument panel, etc.). The instrument cluster 1432 may include a controller and/or supercomputer (e.g., a discrete controller or supercomputer). The instrument cluster 1432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1430 and the instrument cluster 1432. In other words, the instrument cluster 1432 may be included as part of the infotainment SoC 1430, or vice versa.

FIG. 14D is a system diagram for communication between cloud-based server(s) and the example autonomous vehicle 1400 of FIG. 14A, in accordance with some embodiments of the present disclosure. The system 1476 may include server(s) 1478, network(s) 1490, and vehicles, including the vehicle 1400. The server(s) 1478 may include a plurality of GPUs 1484(A)-1484(H) (collectively referred to herein as GPUs 1484), PCIe switches 1482(A)-1482(H) (collectively referred to herein as PCIe switches 1482), and/or CPUs 1480(A)-1480(B) (collectively referred to herein as CPUs 1480). The GPUs 1484, the CPUs 1480, and the PCIe switches may be interconnected with high-speed interconnects such as, for example and without limitation, NVLink interfaces 1488 developed by NVIDIA and/or PCIe connections 1486. In some examples, the GPUs 1484 are connected via NVLink and/or NVSwitch SoC and the GPUs 1484 and the PCIe switches 1482 are connected via PCIe interconnects. Although eight GPUs 1484, two CPUs 1480, and two PCIe switches are illustrated, this is not intended to be limiting. Depending on the embodiment, each of the server(s) 1478 may include any number of GPUs 1484, CPUs 1480, and/or PCIe switches. For example, the server(s) 1478 may each include eight, sixteen, thirty-two, and/or more GPUs 1484.

The server(s) 1478 may receive, over the network(s) 1490 and from the vehicles, image data representative of images showing unexpected or changed road conditions, such as recently commenced road-work. The server(s) 1478 may transmit, over the network(s) 1490 and to the vehicles, neural networks 1492, updated neural networks 1492, and/or map information 1494, including information regarding traffic and road conditions. The updates to the map information 1494 may include updates for the HD map 1422, such as information regarding construction sites, potholes, detours, flooding, and/or other obstructions. In some examples, the neural networks 1492, the updated neural networks 1492, and/or the map information 1494 may have resulted from new training and/or experiences represented in data received from any number of vehicles in the environment, and/or based on training performed at a datacenter (e.g., using the server(s) 1478 and/or other servers).

The server(s) 1478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1490, and/or the machine learning models may be used by the server(s) 1478 to remotely monitor the vehicles.

In some examples, the server(s) 1478 may receive data from the vehicles and apply the data to up-to-date real-time neural networks for real-time intelligent inferencing. The server(s) 1478 may include deep-learning supercomputers and/or dedicated AI computers powered by GPU(s) 1484, such as a DGX and DGX Station machines developed by NVIDIA. However, in some examples, the server(s) 1478 may include deep learning infrastructure that use only CPU-powered datacenters.

The deep-learning infrastructure of the server(s) 1478 may be capable of fast, real-time inferencing, and may use that capability to evaluate and verify the health of the processors, software, and/or associated hardware in the vehicle 1400. For example, the deep-learning infrastructure may receive periodic updates from the vehicle 1400, such as a sequence of images and/or objects that the vehicle 1400 has located in that sequence of images (e.g., via computer vision and/or other machine learning object classification techniques). The deep-learning infrastructure may run its own neural network to identify the objects and compare them with the objects identified by the vehicle 1400 and, if the results do not match and the infrastructure concludes that the AI in the vehicle 1400 is malfunctioning, the server(s) 1478 may transmit a signal to the vehicle 1400 instructing a fail-safe computer of the vehicle 1400 to assume control, notify the passengers, and complete a safe parking maneuver.

For inferencing, the server(s) 1478 may include the GPU(s) 1484 and one or more programmable inference accelerators (e.g., NVIDIA's Tensor®). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 15 is a block diagram of an example computing device(s) 1500 suitable for use in implementing some embodiments of the present disclosure. Computing device 1500 may include an interconnect system 1502 that directly or indirectly couples the following devices: memory 1504, one or more central processing units (CPUs) 1506, one or more graphics processing units (GPUs) 1508, a communication interface 1510, input/output (I/O) ports 1512, input/output components 1514, a power supply 1516, one or more presentation components 1518 (e.g., display(s)), and one or more logic units 1520. In at least one embodiment, the computing device(s) 1500 may comprise one or more virtual machines (VMs), and/or any of the components thereof may comprise virtual components (e.g., virtual hardware components). For non-limiting examples, one or more of the GPUs 1508 may comprise one or more vGPUs, one or more of the CPUs 1506 may comprise one or more vCPUs, and/or one or more of the logic units 1520 may comprise one or more virtual logic units. As such, a computing device(s) 1500 may include discrete components (e.g., a full GPU dedicated to the computing device 1500), virtual components (e.g., a portion of a GPU dedicated to the computing device 1500), or a combination thereof.

Although the various blocks of FIG. 15 are shown as connected via the interconnect system 1502 with lines, this is not intended to be limiting and is for clarity only. For example, in some embodiments, a presentation component 1518, such as a display device, may be considered an I/O component 1514 (e.g., if the display is a touch screen). As another example, the CPUs 1506 and/or GPUs 1508 may include memory (e.g., the memory 1504 may be representative of a storage device in addition to the memory of the GPUs 1508, the CPUs 1506, and/or other components). In other words, the computing device of FIG. 15 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 15.

The interconnect system 1502 may represent one or more links or busses, such as an address bus, a data bus, a control bus, or a combination thereof. The interconnect system 1502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1506 may be directly connected to the memory 1504. Further, the CPU 1506 may be directly connected to the GPU 1508. Where there is direct, or point-to-point connection between components, the interconnect system 1502 may include a PCIe link to carry out the connection. In these examples, a PCI bus need not be included in the computing device 1500.

The memory 1504 may include any of a variety of computer-readable media. The computer-readable media may be any available media that may be accessed by the computing device 1500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1506 may be configured to execute at least some of the computer-readable instructions to control one or more components of the computing device 1500 to perform one or more of the methods and/or processes described herein. The CPU(s) 1506 may each include one or more cores (e.g., one, two, four, eight, twenty-eight, seventy-two, etc.) that are capable of handling a multitude of software threads simultaneously. The CPU(s) 1506 may include any type of processor, and may include different types of processors depending on the type of computing device 1500 implemented (e.g., processors with fewer cores for mobile devices and processors with more cores for servers). For example, depending on the type of computing device 1500, the processor may be an Advanced RISC Machines (ARM) processor implemented using Reduced Instruction Set Computing (RISC) or an x86 processor implemented using Complex Instruction Set Computing (CISC). The computing device 1500 may include one or more CPUs 1506 in addition to one or more microprocessors or supplementary co-processors, such as math co-processors.

In addition to or alternatively from the CPU(s) 1506, the GPU(s) 1508 may be configured to execute at least some of the computer-readable instructions to control one or more components of the computing device 1500 to perform one or more of the methods and/or processes described herein. One or more of the GPU(s) 1508 may be an integrated GPU (e.g., with one or more of the CPU(s) 1506 and/or one or more of the GPU(s) 1508 may be a discrete GPU. In embodiments, one or more of the GPU(s) 1508 may be a coprocessor of one or more of the CPU(s) 1506. The GPU(s) 1508 may be used by the computing device 1500 to render graphics (e.g., 3D graphics) or perform general purpose computations. For example, the GPU(s) 1508 may be used for General-Purpose computing on GPUs (GPGPU). The GPU(s) 1508 may include hundreds or thousands of cores that are capable of handling hundreds or thousands of software threads simultaneously. The GPU(s) 1508 may generate pixel data for output images in response to rendering commands (e.g., rendering commands from the CPU(s) 1506 received via a host interface). The GPU(s) 1508 may include graphics memory, such as display memory, for storing pixel data or any other suitable data, such as GPGPU data. The display memory may be included as part of the memory 1504. The GPU(s) 1508 may include two or more GPUs operating in parallel (e.g., via a link). The link may directly connect the GPUs (e.g., using NVLINK) or may connect the GPUs through a switch (e.g., using NVSwitch). When combined together, each GPU 1508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1506 and/or the GPU(s) 1508, the logic unit(s) 1520 may be configured to execute at least some of the computer-readable instructions to control one or more components of the computing device 1500 to perform one or more of the methods and/or processes described herein. In embodiments, the CPU(s) 1506, the GPU(s) 1508, and/or the logic unit(s) 1520 may discretely or jointly perform any combination of the methods, processes and/or portions thereof. One or more of the logic units 1520 may be part of and/or integrated in one or more of the CPU(s) 1506 and/or the GPU(s) 1508 and/or one or more of the logic units 1520 may be discrete components or otherwise external to the CPU(s) 1506 and/or the GPU(s) 1508. In embodiments, one or more of the logic units 1520 may be a coprocessor of one or more of the CPU(s) 1506 and/or one or more of the GPU(s) 1508.

Examples of the logic unit(s) 1520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1510 may include one or more receivers, transmitters, and/or transceivers that enable the computing device 1500 to communicate with other computing devices via an electronic communication network, included wired and/or wireless communications. The communication interface 1510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1520 and/or communication interface 1510 may include one or more data processing units (DPUs) to transmit data received over a network and/or through interconnect system 1502 directly to (e.g., a memory of) one or more GPU(s) 1508.

The I/O ports 1512 may enable the computing device 1500 to be logically coupled to other devices including the I/O components 1514, the presentation component(s) 1518, and/or other components, some of which may be built in to (e.g., integrated in) the computing device 1500. Illustrative I/O components 1514 include a microphone, mouse, keyboard, joystick, game pad, game controller, satellite dish, scanner, printer, wireless device, etc. The I/O components 1514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1500. The computing device 1500 may be include depth cameras, such as stereoscopic camera systems, infrared camera systems, RGB camera systems, touchscreen technology, and combinations of these, for gesture detection and recognition. Additionally, the computing device 1500 may include accelerometers or gyroscopes (e.g., as part of an inertia measurement unit (IMU)) that enable detection of motion. In some examples, the output of the accelerometers or gyroscopes may be used by the computing device 1500 to render immersive augmented reality or virtual reality.

The power supply 1516 may include a hard-wired power supply, a battery power supply, or a combination thereof. The power supply 1516 may provide power to the computing device 1500 to enable the components of the computing device 1500 to operate.

The presentation component(s) 1518 may include a display (e.g., a monitor, a touch screen, a television screen, a heads-up-display (HUD), other display types, or a combination thereof), speakers, and/or other presentation components. The presentation component(s) 1518 may receive data from other components (e.g., the GPU(s) 1508, the CPU(s) 1506, DPUs, etc.), and output the data (e.g., as an image, video, sound, etc.).

### Example Data Center

FIG. 16 illustrates an example data center 1600 that may be used in at least one embodiments of the present disclosure. The data center 1600 may include a data center infrastructure layer 1610, a framework layer 1620, a software layer 1630, and/or an application layer 1640.

As shown in FIG. 16, the data center infrastructure layer 1610 may include a resource orchestrator 1612, grouped computing resources 1614, and node computing resources (“node C.R.s”) 1616(1)-1616(N), where “N” represents any whole, positive integer. In at least one embodiment, node C.R.s 1616(1)-1616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1616(1)-1616(N) may correspond to a server having one or more of the above-mentioned computing resources. In addition, in some embodiments, the node C.R.s 1616(1)-16161(N) may include one or more virtual components, such as vGPUs, vCPUs, and/or the like, and/or one or more of the node C.R.s 1616(1)-1616(N) may correspond to a virtual machine (VM).

In at least one embodiment, grouped computing resources 1614 may include separate groupings of node C.R.s 1616 housed within one or more racks (not shown), or many racks housed in data centers at various geographical locations (also not shown). Separate groupings of node C.R.s 1616 within grouped computing resources 1614 may include grouped compute, network, memory or storage resources that may be configured or allocated to support one or more workloads. In at least one embodiment, several node C.R.s 1616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1612 may configure or otherwise control one or more node C.R.s 1616(1)-1616(N) and/or grouped computing resources 1614. In at least one embodiment, resource orchestrator 1612 may include a software design infrastructure (SDI) management entity for the data center 1600. The resource orchestrator 1612 may include hardware, software, or some combination thereof.

In at least one embodiment, as shown in FIG. 16, framework layer 1620 may include a job scheduler 1633, a configuration manager 1634, a resource manager 1636, and/or a distributed file system 1638. The framework layer 1620 may include a framework to support software 1632 of software layer 1630 and/or one or more application(s) 1642 of application layer 1640. The software 1632 or application(s) 1642 may respectively include web-based service software or applications, such as those provided by Amazon Web Services, Google Cloud and Microsoft Azure. The framework layer 1620 may be, but is not limited to, a type of free and open-source software web application framework such as Apache Spark™ (hereinafter “Spark”) that may utilize distributed file system 1638 for large-scale data processing (e.g., “big data”). In at least one embodiment, job scheduler 1633 may include a Spark driver to facilitate scheduling of workloads supported by various layers of data center 1600. The configuration manager 1634 may be capable of configuring different layers such as software layer 1630 and framework layer 1620 including Spark and distributed file system 1638 for supporting large-scale data processing. The resource manager 1636 may be capable of managing clustered or grouped computing resources mapped to or allocated for support of distributed file system 1638 and job scheduler 1633. In at least one embodiment, clustered or grouped computing resources may include grouped computing resource 1614 at data center infrastructure layer 1610. The resource manager 1636 may coordinate with resource orchestrator 1612 to manage these mapped or allocated computing resources.

In at least one embodiment, software 1632 included in software layer 1630 may include software used by at least portions of node C.R.s 1616(1)-1616(N), grouped computing resources 1614, and/or distributed file system 1638 of framework layer 1620. One or more types of software may include, but are not limited to, Internet web page search software, e-mail virus scan software, database software, and streaming video content software.

In at least one embodiment, application(s) 1642 included in application layer 1640 may include one or more types of applications used by at least portions of node C.R.s 1616(1)-1616(N), grouped computing resources 1614, and/or distributed file system 1638 of framework layer 1620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1634, resource manager 1636, and resource orchestrator 1612 may implement any number and type of self-modifying actions based on any amount and type of data acquired in any technically feasible fashion. Self-modifying actions may relieve a data center operator of data center 1600 from making possibly bad configuration decisions and possibly avoiding underutilized and/or poor performing portions of a data center.

The data center 1600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1600. In at least one embodiment, trained or deployed machine learning models corresponding to one or more neural networks may be used to infer or predict information using resources described above with respect to the data center 1600 by using weight parameters calculated through one or more training techniques, such as but not limited to those described herein.

In at least one embodiment, the data center 1600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1500 of FIG. 15—e.g., each device may include similar components, features, and/or functionality of the computing device(s) 1500. In addition, where backend devices (e.g., servers, NAS, etc.) are implemented, the backend devices may be included as part of a data center 1600, an example of which is described in more detail herein with respect to FIG. 16.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1500 described herein with respect to FIG. 15. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving first data representative of one or more maps indicating locations of objects within an environment and one or more representations of prior locations of the objects within the environment;
generating, using one or more neural networks and based at least on the first data, second data representative of one or more possible poses for an object, of the objects, within the environment;
generating, using the one or more neural networks and based at least on the first data and the second data, third data representative of one or more possible trajectories for the object within the environment; and
determining, based at least on the third data, a simulated trajectory for the object within the environment.

2. The method of claim 1, further comprising:
generating, using the one or more neural networks and based at least on the first data, fourth data representative of one or more predicted trajectories for one or more second objects, of the objects, within the environment,
wherein the determining the simulated trajectory is further based at least on the fourth data.

3. The method of claim 1, wherein:
the generating the second data uses one or more first neural networks of the one or more neural networks; and
the generating the third data uses one or more second neural networks of the one or more neural networks, the one or more second neural networks being different than the one or more first neural networks.

4. The method of claim 1, further comprising generating fourth data representative of a simulation associated with the environment, the simulation including at least the simulated trajectory for the object within the environment.

5. The method of claim 4, further comprising:
generating, using the one or more neural networks and based at least on the first data, fifth data representative of one or more possible poses for a second object, of the objects, within the environment;
generating, using the one or more neural networks and based at least on the fifth data, sixth data representative of one or more possible trajectories for the second object within the environment; and
determining, based at least on the sixth data, a second simulated trajectory for the second object within the environment
wherein the simulation further includes the second simulated trajectory for the second object within the environment.

6. The method of claim 1, wherein the locations of the objects are associated with a first time and the prior locations of the objects are prior to the first time, and wherein the method further comprises:
generating, based at least on at least a portion of the input data and the simulated trajectory for the object, fourth data representative of one or more second maps indicating second locations of the objects within the environment at a second time and one or more representations of second prior locations of the objects within the environment prior to the second time;
generating, using the one or more neural networks and based at least on the fourth data, fifth data representative of one or more second possible poses for the object within the environment;
generating, using the one or more neural networks and based at least on the fifth data, sixth data representative of one or more second possible trajectories for the object within the environment; and
determining, based at least on the sixth data, a second simulated trajectory for the object within the environment, wherein at least a portion of the second simulated trajectory includes an extension of the simulated trajectory.

7. The method of claim 1, wherein:
the one or more possible trajectories for the object within the environment include at least a first possible trajectory for the object within the environment and a second possible trajectory for the object within the environment; and
the determining the simulated trajectory for the object within the environment comprises:
determining, based at least on the third data, a first score associated with the first possible trajectory and a second score associated with the second possible trajectory; and
determining, based at least on the first score and the second score, that the simulated trajectory includes the first possible trajectory.

8. The method of claim 7, wherein the determining the first score associated with the first possible trajectory and the second score associated with the second possible trajectory is further based at least on one or more of:
one or more locations of one or more roads within the environment; and
one or more distances between the objects.

9. A system comprising:
one or more processing units to:
receive first data representative of one or more maps indicating first locations of objects within an environment at a first time and one or more representations of second locations of the objects within the environment prior to the first time;
generate, using the one or more neural networks and based at least on the first data, second data representative of one or more possible trajectories for a first object, of the objects, within the environment;
generate, using the one or more neural networks and based at least on the first data, third data representative of a predicted trajectory for a second object, of the objects, within the environment; and
determine, based at least on the second data and the third data, a simulated trajectory for the first object within the environment.

10. The system of claim 9, wherein the one or more processing units are further to:
generate, using one or more neural networks and based at least on the first data, fourth data representative of one or more possible poses for the within the environment,
wherein the determination of the second data is further based at least on the fourth data.

11. The system of claim 9, wherein:
the generation of the second data uses one or more first neural networks of the one or more neural networks; and
the generation of the third data uses one or more second neural networks of the one or more neural networks, the one or more second neural networks being different than the one or more first neural networks.

12. The system of claim 9, wherein the one or more processing units are further to generate simulation data representative of a simulation associated with the environment, the simulation including at least the simulated trajectory for the first object within the environment.

13. The system of claim 12, wherein the one or more processing units are further to:
generate, using the one or more neural networks and based at least on the first data, fourth data representative of one or more second possible trajectories the second object within the environment;
generate, using the one or more neural networks and based at least on the first data, fifth data representative of a second predicted trajectory for the second object within the environment; and
determine, based at least on the fourth data and the fifth data, a second simulated trajectory for the second object within the environment
wherein the simulation further includes the second simulated trajectory for the second object within the environment.

14. The system of claim 9, wherein the one or more processing units are further to:
generating, based at least on at least a portion of the input data and the simulated trajectory for the first object, fourth data representative of one or more second maps indicating second locations of the objects within the environment at a second time and one or more representations of second prior locations of the objects within the environment prior to the second time;
generate, using the one or more neural networks and based at least on the fourth data, fifth data representative of one or more second possible trajectories for the first object within the environment;
generate, using the one or more neural networks and based at least on the fourth data, sixth data representative of a second predicted trajectory for the second object within the environment; and
determine, based at least on the fifth data and the sixth data data, a second simulated trajectory for the first object within the environment, wherein at least a portion of the second simulated trajectory includes an extension of the simulated trajectory.

15. The system of claim 9, wherein:
the one or more possible trajectories for the first object within the environment include at least a first possible trajectory for the first object within the environment and a second possible trajectory for the first object within the environment; and
the determination of the simulated trajectory for the first object within the environment comprises:
determining, based at least on the second data and the third data, a first score associated with the first possible trajectory and a second score associated with the second possible trajectory; and
determining, based at least on the first score and the second score, that the simulated trajectory includes the first possible trajectory.

16. The system of claim 15, wherein the determination of the first score associated with the first possible trajectory and the second score associated with the second possible trajectory is further based at least on one or more of:
one or more locations of one or more roads within the environment; and
one or more distances between the objects.

17. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

18. A processor comprising:
one or more processing units to:
receive first data representative of one or more maps indicating first locations of objects within an environment and one or more representations of second locations of the objects within the environment prior to the first time;
generate, using one or more neural networks and based at least on the first data, second data representative of one or more possible poses for an object, of the objects, within the environment;
generate, using the one or more neural networks and based at least on the first data and the second data, third data representative of one or more possible trajectories for the object within the environment; and
determine, based at least on the third data, a simulated trajectory for the object within the environment.

19. The system of claim 18, wherein the one or more processing units are further to:
generate, using the one or more neural networks and based at least on the first data, fourth data representative of one or more predicted trajectories for one or more second objects, of the objects, within the environment,
wherein the determination of the simulated trajectory is further based at least on the fourth data.

20. The processor of claim 18, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
